(19) United States
(12) Patent Application Publication
(10) Pub. No.: US 2022/0083149 A1
(43) Pub. Date: Mar. 17, 2022

(54) COMPUTING INTERFACE SYSTEM

(71) Applicant: Opdig, Inc., Quincy, MA (US)

(72) Inventors: Eric Jeffrey Keller, Quincy, MA (US); Vinh Vi Lam, San Jose, CA (US); Frank Peter Lambrecht, Danville, CA (US)

(21) Appl. No.: 17/531,706

(22) Filed: Nov. 19, 2021

Related U.S. Application Data
(63) Continuation of application No. 14/212,678, filed on Mar. 14, 2014, now abandoned.
(60) Provisional application No. 61/802,143, filed on Mar. 15, 2013.

(51) Int. Cl. G06F 3/01; G06F 3/0488; G06F 3/023

(52) U.S. Cl. CPC G06F 3/017; G06F 3/0233; G06F 3/014; G06F 3/04886

(57) ABSTRACT

Computing interface systems and methods are disclosed. Some implementations include a first accelerometer attached to a first fastening article that is capable of holding the first accelerometer in place on a portion of a thumb of a user. Some implementations may also include a second accelerometer attached to a second fastening article that is capable of holding the second accelerometer in place on a portion of a wrist of a user. Some implementations may additionally or alternatively include magnetometers and/or gyroscopes attached to the first and second fastening articles. Some implementations may also include a processing device configured to receive measurements from the accelerometers, magnetometers, and/or gyroscopes and identify, based on the measurements, symbols associated with motions of a user's hand and/or the orientation of the hand. Some implementations may allow a user to control a cursor in a three dimensional virtual space and interact with objects in that space.

### CROSS-REFERENCE TO RELATED APPLICATION

This application is a continuation of U.S. patent application Ser. No. 14/212,678, filed on Mar. 14, 2014, which claims the benefit of U.S. Provisional Patent Application No. 61/802,143, which was filed on Mar. 15, 2013. The entire contents these applications are hereby incorporated by reference in the specification of this application.

### TECHNICAL FIELD

This disclosure relates to systems and methods for human-computer interaction through hand motions.

### SUMMARY

In a first aspect, in general, the subject matter described in this specification can be embodied in methods that include receiving a first set of acceleration measurements from a first accelerometer that is attached to a thumb of a user. The methods may include detecting, based at least in part on the first set of acceleration measurements, a first event corresponding to engagement of a working surface. The methods may include, during the first event, tracking motion of the first accelerometer, based at least in part on the first set of acceleration measurements. The methods may include determining, based at least in part on the tracked motion of the first accelerometer during the first event, image data. The methods may include transmitting, storing, or displaying the image data.

This and other aspects can each optionally include one or more of the following features. The working surface may correspond to a physical surface. An orientation of the working surface may be determined. Determining the orientation of the working surface may include determining a path through three dimensional space traversed by the first accelerometer during a working surface definition gesture and fitting a plane to the path. A three dimensional position of at least one point on the working surface may be determined. A working surface definition gesture may be detected and an orientation of the working surface may be determined based at least in part on a portion of the first set of acceleration measurements corresponding to the working surface definition gesture. An orientation of a gravity vector may be estimated based on a portion of the first set of acceleration measurements corresponding to a time period at the beginning of the working surface definition gesture. A second set of acceleration measurements may be received from a second accelerometer that is attached to a wrist of the user. Detecting the working surface definition gesture may include detecting, based at least in part on the first set of acceleration measurements and the second set of acceleration measurements, when the thumb of the user is placed in contact with the medial segment of an index finger of the user. Detecting the first event may include detecting, based at least in part on the first set of acceleration measurements and the second set of acceleration measurements, when the thumb of the user is placed in contact with the medial segment of an index finger of the user. A termination of the first event may be detected by detecting, based at least in part on the first set of acceleration measurements and the second set of acceleration measurements, when the thumb of the user is place in an orientation approximately orthogonal to the length of a forearm of the user. A first set of magnetic flux measurements may be received from a first magnetometer that is attached to the thumb of the user and a second set of magnetic flux measurements may be received from a second magnetometer that is attached to the wrist of the user. Detecting the first event may include detecting, based at least in part on the first set of acceleration measurements and the second set of acceleration measurements and the first set of magnetic flux measurements and the second set of magnetic flux measurements, when the thumb of the user is placed in an orientation indicating engagement of the working surface. Detecting the first event may include tracking the position of the first accelerometer and detecting when a distance between the first accelerometer and the working surface is below a threshold. A tap of the thumb of the user against a tap target on a finger of the user may be detected, based at least in part on the first set of acceleration measurements. A virtual writing utensil may be configured, based in part on the tap detected, for editing an image based on the tracked motion of the first accelerometer during the first event. Determining the image data may include receiving a first set of angular rate measurements from a first gyroscope that is attached to the thumb of the user and compensating, based at least in part on the first set of angular rate measurements, for variations in the orientation of the first accelerometer with respect to the orientation of the working surface. A sequence of taps against a sensor module housing the second accelerometer may be detected, based at least in part on the second set of acceleration measurements. A hand-writing mode may be initiated upon detection of the sequence of taps against the sensor module. Initiating hand-writing mode may include prompting the user to perform a working surface definition gesture. The image data may be encoded as text.

In a second aspect, in general, the subject matter described in this specification can be embodied in systems that include a data processing apparatus and a data storage device storing instructions executable by the data processing apparatus that upon execution by the data processing apparatus cause the data processing apparatus to perform operations including receiving a first set of acceleration measurements from a first accelerometer that is attached to a thumb of a user. The operations may include detecting, based at least in part on the first set of acceleration measurements, a first event corresponding to engagement of a working surface. The operations may include during the first event, tracking motion of the first accelerometer, based at least in part on the first set of acceleration measurements. The operations may include determining, based at least in part on the tracked motion of the first accelerometer during the first event, image data. The operations may include transmitting, storing, or displaying the image data.

This and other aspects can each optionally include one or more of the following features. The working surface may correspond to a physical surface. An orientation of the working surface may be determined. Determining the orientation of the working surface may include determining a path through three dimensional space traversed by the first accelerometer during a working surface definition gesture and fitting a plane to the path. A three dimensional position of at least one point on the working surface may be determined. A working surface definition gesture may be detected and an orientation of the working surface may be determined based at least in part on a portion of the first set of acceleration measurements corresponding to the working surface definition gesture. An orientation of a gravity vector may be estimated based on a portion of the first set of acceleration measurements corresponding to a time period at the beginning of the working surface definition gesture. A second set of acceleration measurements may be received from a second accelerometer that is attached to a wrist of the user. Detecting the working surface definition gesture may include detecting, based at least in part on the first set of acceleration measurements and the second set of acceleration measurements, when the thumb of the user is placed in contact with the medial segment of an index finger of the user. Detecting the first event may include detecting, based at least in part on the first set of acceleration measurements and the second set of acceleration measurements, when the thumb of the user is placed in contact with the medial segment of an index finger of the user. A termination of the first event may be detected by detecting, based at least in part on the first set of acceleration measurements and the second set of acceleration measurements, when the thumb of the user is place in an orientation approximately orthogonal to the length of a forearm of the user. A first set of magnetic flux measurements may be received from a first magnetometer that is attached to the thumb of the user and a second set of magnetic flux measurements may be received from a second magnetometer that is attached to the wrist of the user. Detecting the first event may include detecting, based at least in part on the first set of acceleration measurements and the second set of acceleration measurements and the first set of magnetic flux measurements and the second set of magnetic flux measurements, when the thumb of the user is placed in an orientation indicating engagement of the working surface. Detecting the first event may include tracking the position of the first accelerometer and detecting when a distance between the first accelerometer and the working surface is below a threshold. A tap of the thumb of the user against a tap target on a finger of the user may be detected, based at least in part on the first set of acceleration measurements. A virtual writing utensil may be configured, based in part on the tap detected, for editing an image based on the tracked motion of the first accelerometer during the first event. Determining the image data may include receiving a first set of angular rate measurements from a first gyroscope that is attached to the thumb of the user and compensating, based at least in part on the first set of angular rate measurements, for variations in the orientation of the first accelerometer with respect to the orientation of the working surface. A sequence of taps against a sensor module housing the second accelerometer may be detected, based at least in part on the second set of acceleration measurements. A hand-writing mode may be initiated upon detection of the sequence of taps against the sensor module. Initiating hand-writing mode may include prompting the user to perform a working surface definition gesture. The image data may be encoded as text.

In a third aspect, in general, the subject matter described in this specification can be embodied in methods that include prompting a user to perform a gesture in order to access a target computing device. The methods may include receiving a first set of acceleration measurements from a first accelerometer that is attached to a thumb of the user. The methods may include receiving a second set of acceleration measurements from a second accelerometer that is attached to a wrist of the user. The methods may include determining, based at least in part on the first set of acceleration measurements and the second set of acceleration measurements, whether a gesture performed by the user matches a previously registered gesture for a user profile that has access permission for the target computing device. The methods may include granting access to the target computing device, where the gesture performed by the user is determined to match the previously registered gesture.

This and other aspects can each optionally include one or more of the following features. Determining whether the gesture performed by the user matches the registered gesture may include detecting, based at least in part on the first set of acceleration measurements and the second set of acceleration measurements, a sequence of taps of the thumb of the user against one or more tap targets on fingers of the user; mapping the sequence of tap targets to a sequence of characters; and determining whether the sequence of characters matches a sequence of characters matches a password previously registered for the user profile. Determining whether the gesture performed by the user matches the registered gesture may include determining a cross-correlation between a recording of sensor measurements for the gesture performed by the user, comprising at least a portion of the first set of acceleration measurements and at least a portion of the second set of acceleration measurements, and a record of sensor measurements representing the registered gesture for the user profile and determining whether the cross-correlation is above a threshold. A first set of magnetic flux measurements may be received from a first magnetometer that is attached to the thumb of the user. A second set of magnetic flux measurements may be received from a second magnetometer that is attached to the wrist of the user. Determining whether the gesture performed by the user matches the registered gesture may also be based at least in part on the first set of magnetic flux measurements and the second set of magnetic flux measurements. The gesture may be registered for the user profile that is used to control access to the target computing device. Registering the gesture for the user profile may include prompting a user to perform multiple instances of the gesture; recording sensor measurements, including at least acceleration measurements from the first accelerometer and acceleration measurements from the second accelerometer, associated with each of the instances of the gesture; determining cross-correlations between the recordings of sensor measurements for each of the instances of the gesture; determining whether the cross-correlations are above a threshold; and, where the cross-correlations are above the threshold, storing a record of sensor measurements representing the gesture for the user profile. An encrypted wireless communications link may be established between an interface, including the first accelerometer and the second accelerometer, and the target computing device. Encryption keys may be exchanged with the target computing device via near field communications. Public encryption keys may be exchanged with the target computing device via near field communications.

In a fourth aspect, in general, the subject matter described in this specification can be embodied in systems that include a data processing apparatus and a data storage device storing instructions executable by the data processing apparatus that upon execution by the data processing apparatus cause the data processing apparatus to perform operations including prompting a user to perform a gesture in order to access a target computing device. The operations may include receiving a first set of acceleration measurements from a first accelerometer that is attached to a thumb of the user. The operations may include receiving a second set of acceleration measurements from a second accelerometer that is attached to a wrist of the user. The operations may include determining, based at least in part on the first set of acceleration measurements and the second set of acceleration measurements, whether a gesture performed by the user matches a previously registered gesture for a user profile that has access permission for the target computing device. The operations may include granting access to the target computing device, where the gesture performed by the user is determined to match the previously registered gesture.

This and other aspects can each optionally include one or more of the following features. Determining whether the gesture performed by the user matches the registered gesture may include detecting, based at least in part on the first set of acceleration measurements and the second set of acceleration measurements, a sequence of taps of the thumb of the user against one or more tap targets on fingers of the user; mapping the sequence of tap targets to a sequence of characters; and determining whether the sequence of characters matches a sequence of characters matches a password previously registered for the user profile. Determining whether the gesture performed by the user matches the registered gesture may include determining a cross-correlation between a recording of sensor measurements for the gesture performed by the user, comprising at least a portion of the first set of acceleration measurements and at least a portion of the second set of acceleration measurements, and a record of sensor measurements representing the registered gesture for the user profile and determining whether the cross-correlation is above a threshold. A first set of magnetic flux measurements may be received from a first magnetometer that is attached to the thumb of the user. A second set of magnetic flux measurements may be received from a second magnetometer that is attached to the wrist of the user. Determining whether the gesture performed by the user matches the registered gesture may also be based at least in part on the first set of magnetic flux measurements and the second set of magnetic flux measurements. The gesture may be registered for the user profile that is used to control access to the target computing device. Registering the gesture for the user profile may include prompting a user to perform multiple instances of the gesture; recording sensor measurements, including at least acceleration measurements from the first accelerometer and acceleration measurements from the second accelerometer, associated with each of the instances of the gesture; determining cross-correlations between the recordings of sensor measurements for each of the instances of the gesture; determining whether the cross-correlations are above a threshold; and, where the cross-correlations are above the threshold, storing a record of sensor measurements representing the gesture for the user profile. An encrypted wireless communications link may be established between an interface, including the first accelerometer and the second accelerometer, and the target computing device. Encryption keys may be exchanged with the target computing device via near field communications. Public encryption keys may be exchanged with the target computing device via near field communications.

In a fifth aspect, in general, the subject matter described in this specification can be embodied in methods that include receiving a first set of acceleration measurements from a first accelerometer that is attached to a thumb of the user. The methods may include receiving a second set of acceleration measurements from a second accelerometer that is attached to a wrist of the user. The methods may include detecting, based at least in part on the first set of acceleration measurements and the second set of acceleration measurements, when the thumb of the user has been tapped against a tap target on a finger of the user. The methods may include detecting change in orientation of the wrist of the user that occurs while the thumb of the user is held in place on the tap target. The methods may include adjusting a control parameter for an application or service running on a target computing device based on the change in orientation. The methods may include detecting when the thumb of the user has been removed from the tap target.

This and other aspects can each optionally include one or more of the following features. The change in orientation may be change in the inclination of the wrist of the user. The change in orientation may be detected based at least in part of the second set of acceleration measurements. A first set of angular rate measurements may be received from a first gyroscope that is attached to the wrist of the user. The change in orientation may be detected based at least in part of the first set of angular rate measurements. A first set of magnetic flux measurements may be received from a first magnetometer that is attached to the wrist of the user. The change in orientation may be detected based at least in part of the first set of magnetic flux measurements. The control parameter may vary in a range that includes three or more values and the control parameter may be adjusted in an amount that is proportional to the change in orientation. The control parameter may vary in a range that includes three or more values and the control parameter may be adjusted in an amount that is proportional to the rate of change in orientation. The control parameter may control a volume of sound produced by the target computing device. The control parameter may control a zoom factor of an image rendered by the target computing device. The control parameter may control a scroll bar position of a window rendered on display by the target computing device. The change in orientation may be caused by an arm of the user being waved in a circle. The change in orientation may be caused by the wrist of the user being twisted. A first set of magnetic flux measurements may be received from a first magnetometer that is attached to the thumb of the user. A second set of magnetic flux measurements may be received from a second magnetometer that is attached to the wrist of the user. Detecting when the thumb of the user has been tapped against a tap target on the finger of the user may be based at least in part on the first set of magnetic flux measurements and the second set of magnetic flux measurements.

In a sixth aspect, in general, the subject matter described in this specification can be embodied in systems that include a data processing apparatus and a data storage device storing instructions executable by the data processing apparatus that upon execution by the data processing apparatus cause the data processing apparatus to perform operations including receiving a first set of acceleration measurements from a first accelerometer that is attached to a thumb of the user. The operations may include receiving a second set of acceleration measurements from a second accelerometer that is attached to a wrist of the user. The operations may include detecting, based at least in part on the first set of acceleration measurements and the second set of acceleration measurements, when the thumb of the user has been tapped against a tap target on a finger of the user. The operations may include detecting change in orientation of the wrist of the user that occurs while the thumb of the user is held in place on the tap target. The operations may include adjusting a control parameter for an application or service running on a target computing device based on the change in orientation. The operations may include detecting when the thumb of the user has been removed from the tap target.

This and other aspects can each optionally include one or more of the following features. The change in orientation may be change in the inclination of the wrist of the user. The change in orientation may be detected based at least in part of the second set of acceleration measurements. A first set of angular rate measurements may be received from a first gyroscope that is attached to the wrist of the user. The change in orientation may be detected based at least in part of the first set of angular rate measurements. A first set of magnetic flux measurements may be received from a first magnetometer that is attached to the wrist of the user. The change in orientation may be detected based at least in part of the first set of magnetic flux measurements. The control parameter may vary in a range that includes three or more values and the control parameter may be adjusted in an amount that is proportional to the change in orientation. The control parameter may vary in a range that includes three or more values and the control parameter may be adjusted in an amount that is proportional to the rate of change in orientation. The control parameter may control a volume of sound produced by the target computing device. The control parameter may control a zoom factor of an image rendered by the target computing device. The control parameter may control a scroll bar position of a window rendered on display by the target computing device. The change in orientation may be caused by an arm of the user being waved in a circle. The change in orientation may be caused by the wrist of the user being twisted. A first set of magnetic flux measurements may be received from a first magnetometer that is attached to the thumb of the user. A second set of magnetic flux measurements may be received from a second magnetometer that is attached to the wrist of the user. Detecting when the thumb of the user has been tapped against a tap target on the finger of the user may be based at least in part on the first set of magnetic flux measurements and the second set of magnetic flux measurements.

In a seventh aspect, in general, the subject matter described in this specification can be embodied in methods that include receiving a first set of acceleration measurements from a first accelerometer that is attached to a thumb of the user. The methods may include receiving a second set of acceleration measurements from a second accelerometer that is attached to a wrist of the user. The methods may include detecting, based at least in part on the first set of acceleration measurements and the second set of acceleration measurements, when the thumb of the user has been tapped against a tap target on a finger of the user. The methods may include detecting change in orientation of the thumb of the user that occurs while the thumb of the user is swiped along the length of the finger. The methods may include adjusting a control parameter for an application or service running on a target computing device based on the change in orientation.

This and other aspects can each optionally include one or more of the following features. The change in orientation may be detected based at least in part of the first set of acceleration measurements. A first set of angular rate measurements may be received from a first gyroscope that is attached to the thumb of the user. The change in orientation may be detected based at least in part of the first set of angular rate measurements. The control parameter may vary in a range that includes three or more values and the control parameter may be adjusted in an amount that is proportional to the change in orientation. The control parameter may vary in a range that includes three or more values and the control parameter may be adjusted in an amount that is proportional to the rate of change in orientation. The control parameter may control a volume of sound produced by the target computing device. The control parameter may control a zoom factor of an image rendered by the target computing device. The control parameter may control a scroll bar position of a window rendered on display by the target computing device. A first set of magnetic flux measurements may be received from a first magnetometer that is attached to the thumb of the user. A second set of magnetic flux measurements may be received from a second magnetometer that is attached to the wrist of the user. Detecting when the thumb of the user has been tapped against a tap target on the finger of the user may be based at least in part on the first set of magnetic flux measurements and the second set of magnetic flux measurements.

In an eighth aspect, in general, the subject matter described in this specification can be embodied in systems that include a data processing apparatus and a data storage device storing instructions executable by the data processing apparatus that upon execution by the data processing apparatus cause the data processing apparatus to perform operations including receiving a first set of acceleration measurements from a first accelerometer that is attached to a thumb of the user. The operations may include receiving a second set of acceleration measurements from a second accelerometer that is attached to a wrist of the user. The operations may include detecting, based at least in part on the first set of acceleration measurements and the second set of acceleration measurements, when the thumb of the user has been tapped against a tap target on a finger of the user. The operations may include detecting change in orientation of the thumb of the user that occurs while the thumb of the user is swiped along the length of the finger. The operations may include adjusting a control parameter for an application or service running on a target computing device based on the change in orientation.

This and other aspects can each optionally include one or more of the following features. The change in orientation may be detected based at least in part of the first set of acceleration measurements. A first set of angular rate measurements may be received from a first gyroscope that is attached to the thumb of the user. The change in orientation may be detected based at least in part of the first set of angular rate measurements. The control parameter may vary in a range that includes three or more values and the control parameter may be adjusted in an amount that is proportional to the change in orientation. The control parameter may vary in a range that includes three or more values and the control parameter may be adjusted in an amount that is proportional to the rate of change in orientation. The control parameter may control a volume of sound produced by the target computing device. The control parameter may control a zoom factor of an image rendered by the target computing device. The control parameter may control a scroll bar position of a window rendered on display by the target computing device. A first set of magnetic flux measurements may be received from a first magnetometer that is attached to the thumb of the user. A second set of magnetic flux measurements may be received from a second magnetometer that is attached to the wrist of the user. Detecting when the thumb of the user has been tapped against a tap target on the finger of the user may be based at least in part on the first set of magnetic flux measurements and the second set of magnetic flux measurements.

In a ninth aspect, in general, the subject matter described in this specification can be embodied in methods that include receiving a first set of acceleration measurements from a first accelerometer that is attached to a thumb of the user. The methods may include receiving a second set of acceleration measurements from a second accelerometer that is attached to a wrist of the user. The methods may include detecting, based at least in part on the first set of acceleration measurements and the second set of acceleration measurements, when the thumb of the user has been bent back at the wrist of the user. The methods may include in response to detecting that the thumb of the user has been bent back at the wrist of the user, issuing a command in an application running on a target computing device.

This and other aspects can each optionally include one or more of the following features. The command may cause the application to stop or pause the play of media content. Detecting when the thumb of the user has been bent back at the wrist of the user may include determining an angle between an orientation of the first accelerometer and an orientation of the second accelerometer and determining whether the angle is below a threshold. A first set of magnetic flux measurements may be received from a first magnetometer that is attached to the thumb of the user. A second set of magnetic flux measurements may be received from a second magnetometer that is attached to the wrist of the user. Detecting when the thumb of the user has been bent back at the wrist of the user may be based at least in part on the first set of magnetic flux measurements and the second set of magnetic flux measurements.

In a tenth aspect, in general, the subject matter described in this specification can be embodied in systems that include a data processing apparatus and a data storage device storing instructions executable by the data processing apparatus that upon execution by the data processing apparatus cause the data processing apparatus to perform operations including receiving a first set of acceleration measurements from a first accelerometer that is attached to a thumb of the user. The operations may include receiving a second set of acceleration measurements from a second accelerometer that is attached to a wrist of the user. The operations may include detecting, based at least in part on the first set of acceleration measurements and the second set of acceleration measurements, when the thumb of the user has been bent back at the wrist of the user. The operations may include in response to detecting that the thumb of the user has been bent back at the wrist of the user, issuing a command in an application running on a target computing device.

This and other aspects can each optionally include one or more of the following features. The command may cause the application to stop or pause the play of media content. Detecting when the thumb of the user has been bent back at the wrist of the user may include determining an angle between an orientation of the first accelerometer and an orientation of the second accelerometer and determining whether the angle is below a threshold. A first set of magnetic flux measurements may be received from a first magnetometer that is attached to the thumb of the user. A second set of magnetic flux measurements may be received from a second magnetometer that is attached to the wrist of the user. Detecting when the thumb of the user has been bent back at the wrist of the user may be based at least in part on the first set of magnetic flux measurements and the second set of magnetic flux measurements.

In an eleventh aspect, in general, the subject matter described in this specification can be embodied in methods that include receiving a first set of acceleration measurements from a first accelerometer that is attached to a thumb of the user. The methods may include receiving a second set of acceleration measurements from a second accelerometer that is attached to a wrist of the user. The methods may include detecting, based at least in part on the first set of acceleration measurements or the second set of acceleration measurements, an activity state of the user. The methods may include adjusting, based on the activity state of the user, a selection of gestures that are enabled through a computing interface comprising the first accelerometer and the second accelerometer.

This and other aspects can each optionally include one or more of the following features. The activity state may be running. Detecting the activity state may include detecting periodic swings of an arm of the user that are characteristic of running motion. The activity state may be resting. The activity state may be motor vehicle riding. Detecting the activity state may include detecting vibrations that are characteristic of a motor. Detecting the activity state may include detecting a sustained velocity exceeding a threshold. Adjusting the selection of gestures that are enabled may include disabling a gesture that controls the volume of sound. One or more components in the computing interface may be powered down. One or more components in the computing interface may be powered up. A control parameter of a target computing device may be configured based on the activity state of the user. The control parameter may be used to prevent incoming telephone calls from causing a notification. The control parameter may be used to enable incoming telephone calls to cause a notification. A user profile may be retrieved that specifies how the selection of gestures that are enabled will be adjusted for an activity state of the user. The user profile or a pointer to the user profile may be transmitted from the computing interface to a target computing device.

In a twelfth aspect, in general, the subject matter described in this specification can be embodied in systems that include a data processing apparatus and a data storage device storing instructions executable by the data processing apparatus that upon execution by the data processing apparatus cause the data processing apparatus to perform operations including receiving a first set of acceleration measurements from a first accelerometer that is attached to a thumb of the user. The operations may include receiving a second set of acceleration measurements from a second accelerometer that is attached to a wrist of the user. The operations may include detecting, based at least in part on the first set of acceleration measurements or the second set of acceleration measurements, an activity state of the user. The operations may include adjusting, based on the activity state of the user, a selection of gestures that are enabled through a computing interface comprising the first accelerometer and the second accelerometer.

This and other aspects can each optionally include one or more of the following features. The activity state may be running. Detecting the activity state may include detecting periodic swings of an arm of the user that are characteristic of running motion. The activity state may be resting. The activity state may be motor vehicle riding. Detecting the activity state may include detecting vibrations that are characteristic of a motor. Detecting the activity state may include detecting a sustained velocity exceeding a threshold. Adjusting the selection of gestures that are enabled may include disabling a gesture that controls the volume of sound. One or more components in the computing interface may be powered down. One or more components in the computing interface may be powered up. A control parameter of a target computing device may be configured based on the activity state of the user. The control parameter may be used to prevent incoming telephone calls from causing a notification. The control parameter may be used to enable incoming telephone calls to cause a notification. A user profile may be retrieved that specifies how the selection of gestures that are enabled will be adjusted for an activity state of the user. The user profile or a pointer to the user profile may be transmitted from the computing interface to a target computing device.

In a thirteenth aspect, in general, the subject matter described in this specification can be embodied in methods that include receiving a context update message from a target computing device. The methods may include adjusting, in response to the context update message, a selection of gestures that are enabled through a computing interface comprising a first accelerometer that is attached to a thumb of a user and a second accelerometer that is attached to a wrist of the user.

This and other aspects can each optionally include one or more of the following features. One or more components in the computing interface may be powered down. One or more components in the computing interface may be powered up. A user profile may be retrieved that specifies how the selection of gestures that are enabled will be adjusted in response to a context update message. The user profile or a pointer to the user profile may be transmitted from the computing interface to a target computing device.

In a fourteenth aspect, in general, the subject matter described in this specification can be embodied in systems that include a data processing apparatus and a data storage device storing instructions executable by the data processing apparatus that upon execution by the data processing apparatus cause the data processing apparatus to perform operations including receiving a context update message from a target computing device. The operations may include adjusting, in response to the context update message, a selection of gestures that are enabled through a computing interface comprising a first accelerometer that is attached to a thumb of a user and a second accelerometer that is attached to a wrist of the user.

This and other aspects can each optionally include one or more of the following features. One or more components in the computing interface may be powered down. One or more components in the computing interface may be powered up. A user profile may be retrieved that specifies how the selection of gestures that are enabled will be adjusted in response to a context update message. The user profile or a pointer to the user profile may be transmitted from the computing interface to a target computing device.

In a fifteenth aspect, in general, the subject matter described in this specification can be embodied in methods that include receiving a first set of acceleration measurements from a first accelerometer that is attached to a thumb of the user. The methods may include receiving a second set of acceleration measurements from a second accelerometer that is attached to a wrist of the user. The methods may include transmitting the first set of acceleration measurements and the second set of acceleration measurements to a first target computing device. The methods may include receiving one or more commands from the first target computing device, in response to detection, based at least in part on the first set of acceleration measurements or the second set of acceleration measurements, of a device selection gesture performed by the user. The methods may include in response to the one or more commands, establishing a wireless communications link between a second target computing device and a computing interface comprising the first accelerometer and the second accelerometer.

This and other aspects can each optionally include one or more of the following features. A user profile may be retrieved that specifies the device selection gesture and the one or more commands. The user profile or a pointer to the user profile may be transmitted from the computing interface to the first target computing device.

In a sixteenth aspect, in general, the subject matter described in this specification can be embodied in systems that include a data processing apparatus and a data storage device storing instructions executable by the data processing apparatus that upon execution by the data processing apparatus cause the data processing apparatus to perform operations including receiving a first set of acceleration measurements from a first accelerometer that is attached to a thumb of the user. The operations may include receiving a second set of acceleration measurements from a second accelerometer that is attached to a wrist of the user. The operations may include transmitting the first set of acceleration measurements and the second set of acceleration measurements to a first target computing device. The operations may include receiving one or more commands from the first target computing device, in response to detection, based at least in part on the first set of acceleration measurements or the second set of acceleration measurements, of a device selection gesture performed by the user. The operations may include in response to the one or more commands, establishing a wireless communications link between a second target computing device and a computing interface comprising the first accelerometer and the second accelerometer.

This and other aspects can each optionally include one or more of the following features. A user profile may be retrieved that specifies the device selection gesture and the one or more commands. The user profile or a pointer to the user profile may be transmitted from the computing interface to the first target computing device.

Implementations may include zero or more of the following advantages. Some implementations may reliably detect and classify hand gestures to allow a user to control a computing device. Some implementations may include sensor components that are comfortably wearable on a thumb and/or wrist of a user. Some implementations may enable a user to input alpha-numeric text or other symbols to a computing device. Some implementations may enable a user to manipulate a cursor in a two dimensional or a three dimensional virtual workspace. Some implementations may be robust to environmental noise such as vibrations or accelerations experienced in a moving vehicle. Some implementations may enable a user to enter text on mobile device without using limited display space to present keys. Some implementations may enable a user to enter symbols or commands to a computing device by tapping tap targets without looking at those targets. Some implementations may enable a user to draw pictures or write text by tracing on image with the tip of a finger on a working surface. Some implementations may provide secure access to a computing device. Some implementations may authenticate an authorized user of the interface. Some implementations may facilitate controlling and/or inputting data to multiple computing devices by allowing simple switching of the of the target computing device for the interface. Some implementations may allow the use of gestures to control application and/or context specific functions.

The details of one or more examples are set forth in the accompanying drawings and the description below. Further features, aspects, and advantages of the disclosed invention will become apparent from the description, the drawings, and the claims.

### DESCRIPTION OF THE DRAWINGS

FIG. 1 is a drawing of an example interface ring.

FIG. 2 is a drawing of an example interface wrist band.

FIG. 3 is a drawing of a hand wearing an example interface ring and wrist band with the thumb pressed to the distal phalanx of the middle finger.

FIG. 4 is a drawing of a hand with example target locations on the fingers indicated.

FIG. 5 is a drawing of a user wearing an an interface ring and wrist band and tapping a target with the forearm perpendicular to the Earth radius.

FIG. 6 is a drawing of a user wearing an an interface ring and wrist band and tapping a target with the forearm at 50-degree angle to the Earth radius.

FIG. 7 is a drawing of a user wearing an an interface ring and wrist band and tapping a target with the palm facing up.

FIG. 8 is a drawing of a user wearing an an interface ring and wrist band and tapping a target with the palm facing sideways.

FIG. 9 is a drawing of an example interface system, which includes a combined processing-and-display unit, an interface ring, and an interface wrist band.

FIG. 10A-10C are a table illustrating an example mapping of tap-target and hand-orientation pairs to distinct characters.

FIG. 11 is a flowchart of an example process 1100 for interpreting signals from a user computing interface.

FIG. 12 is a flowchart of an example process 1200 for interpreting signals from a user computing interface to enable a hand-writing mode.

### DETAILED DESCRIPTION

Computing interfaces are described for controlling a target computing device (e.g., a smart-phone, a tablet device, a laptop computer, a television, automobile environmental control system, or some other device that includes a microprocessor and accepts user input). In some implementations, a computer interface includes a sensor module that is attached to fastening article (e.g., a ring band, an adhesive substrate, or a glove with a thumb sleeve) that is capable of holding the sensor module in place on a portion of a thumb of a user. The sensor module may include an accelerometer, a magnetometer, and/or a gyroscope. In some implementations, a computing interface also includes a reference sensor module that may be attached to fastening article (e.g., a wrist band or sleeve) that is capable of holding the reference sensor module in place on a portion of the wrist of a user (or some other reference location on the hand or forearm of the user). A reference sensor module may include an accelerometer, a magnetometer, and/or a gyroscope.

A sensor module of a computing interface may also include a micro-controller or microprocessor, a wireless transmitter, and/or a battery. In some implementations, two sensor modules of an interface may be connected by two or more wires (e.g., a serial port cable), and only one of the sensor modules includes a battery that supplies power to both sensor modules. In some implementations, each sensor module has its own battery and is configured to transmit measurements (e.g., acceleration measurements, magnetic flux measurements, and/or angular rate measurements) from one or more sensors in the sensor module to a remote computing device via a wireless communications link (e.g., a Bluetooth link). In some implementations, a sensor module transmits (e.g., via wireless communications link) its sensor measurements to another sensor module in the interface rather than directly to a remote computing device. Data based on sensor measurements from multiple sensor modules may be transmitted from one of the sensor modules (e.g., a reference sensor module attached to wrist) to a computing device that the user seeks to control or provide input to. For example, measurements from all the sensors in an interface may be forwarded to the target computing device via a transmitter (e.g., a Bluetooth transmitter) included in a reference sensor module. In some implementations, one of the sensor modules (a reference sensor module attached to wrist) includes a processing device (e.g., a micro-controller or a microprocessor) that analyzes sensor measurements from sensors of the interface and transmits other data based on those measurements to the target computing device. For example, symbols assigned to thumb taps detected by the interface may be transmitted to a target computing device.

In some implementations, processing to interpret the measurements from one or more sensors of an interface is performed by an application or device driver that runs on the target computing device.

Example processes are described for interpreting measurements from sensors in various interface configurations. The example interfaces with corresponding processes may enable a computing device to determine when a thumb of a user wearing an interface is tapped against a surface. For example, a user's thumb may be tapped against one of a set of configured tap targets on the other fingers of the user. These tap events may be detected and classified to identify which tap target was tapped and to map that tap gesture to a corresponding symbol that the user intends to input to the target computing device. In some implementations, the orientation of a user's wrist may be determined and used to select among multiple symbols assigned to an individual tap target.

In some implementations, an interface may support a cursor manipulation mode that enables a user to interact with objects in a virtual space (e.g., a two dimensional or three dimensional virtual space). For example, when in cursor manipulation mode, acceleration measurements from an accelerometer in the interface analyzed to control the movement of a cursor in the virtual space. In some implementations, angular rate measurements from a gyroscope in an interface may be interpreted to enable a user to rotate objects in virtual space that have been selected with a cursor while in a cursor manipulation mode.

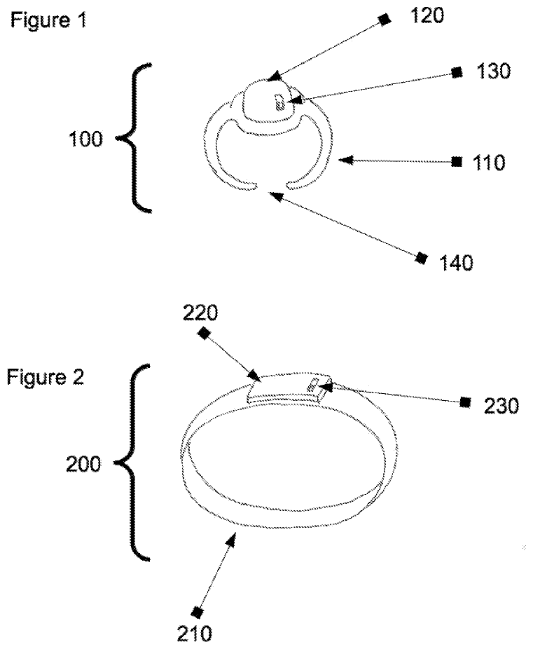

Referring to FIG. 1, a computing interface may include a ring 100 that may be worn on a user's thumb. The ring includes a band 110 and one or more accelerometers, magnetometers, or gyroscopes (collectively, a set of sensors) that are located in an electronic component housing 120. The ring may include a single tri-axial or multiple dual-axis and/or single axis sensors to span the three dimensional space. In some implementations, the axes of different types of sensors in the component housing 120 may be aligned. In some implementations, the axes of different types of sensors in the component housing 120 may be aligned electronically via a calibration process. The ring may also include a radio frequency transmitting device, such as a Bluetooth transmitter, and a battery. The electronic component housing may include a switch 130 for powering the electronics components up and down.

The accelerometer may measure the spatial orientation of the thumb and its motion. For example, when the thumb is tapped against a target, such as phalanges on the other fingers of the hand, an abrupt deceleration results that is detected by the accelerometer. A transmitter may be used to send sensor measurements from the ring to an external processing device. A transmitter may also be used to send information about events derived from sensor measurements to an external processing device.

The ring band 110 serves to hold the interface ring 100 in place on a user's thumb. As thumb size may vary between users, it may be advantageous to make the ring band flexible enough to comfortably fit thumbs of different sizes. The ring band may be made of plastic, or another flexible material. The ring band may be of approximately circular shape with a single gap 140 that allows the ring band to flex to surround most of the circumference of a user's thumb. The ring band may alternatively be formed into a complete loop that completely encircles the user's thumb when worn. In this case the ring band may be made of a material, such as nylon, that is capable of stretching in a longitudinal direction. Alternatively the ring band may be rigid and fitted to a particular thumb size.

In some implementations, a ring 100 may also include a wireless receiver (e.g., a Bluetooth receiver) for receiving information from a target computing device or an intermediary device. For example, the ring may receive configuration commands from target computing device that set operating parameters of the ring, such as a usage mode (e.g., to enter a cursor control mode), a power-saving mode, a sampling rate for one or more sensors, etc.

In some implementations, a portion of the ring that includes a Bluetooth transmitter may be detachable from the band. This portion may also include a speaker and microphone that allow the detachable component to be used as a Bluetooth enabled earbud for a cellphone.

Referring to FIG. 2, an example computing interface may include a bracelet 200 that may be worn on a user's wrist. The bracelet includes a wristband 210 and one or more accelerometers, magnetometers, or gyroscopes (collectively, a set of sensors) that are located in an electronic component housing 220. The bracelet may include a single tri-axial or multiple dual-axis and/or single axis sensors to span the three dimensional space. In some implementations, the axes of different types of sensors in the component housing 220 may be aligned. In some implementations, the axes of different types of sensors in the component housing 220 may be aligned electronically via a calibration process. The bracelet may also include a radio frequency transmitting device, such as a Bluetooth transmitter, and a battery. The accelerometer may measure spatial orientation of the wrist and its motion. A transmitter may be used to send sensor measurements from the bracelet to an external processing device. A transmitter may also be used to send information about events derived from the sensor measurements to an external processing device. The electronic component housing may include a switch 230 for powering the electronics components up and down.

The wristband 210 serves to hold component(s) of the interface in place on a user's wrist. As wrist size may vary between users, it may be advantageous to make the wristband flexible enough to comfortably fit wrists of different sizes. The wristband may be made a flexible material, such as rubber, nylon, or plastic. The wristband may include an adjustable fastening device, such a Velcro strip, snaps, cable tie, or a buckle. The wristband may be formed into a complete loop that completely encircles the user's wrist when worn. Alternatively, the wristband may be a continuous loop made of a material, such as rubber or nylon that is capable of stretching in a longitudinal direction to allow the band to slide over the hand of the user and still fit the wrist tight enough to hold an accelerometer in place on the wrist.

In some implementations, a bracelet 200 may also include a wireless receiver (e.g., a Bluetooth receiver) for receiving information from a target computing device or an intermediary device. For example, the ring may receive configuration commands from target computing device that set operating parameters of the ring, such as a usage mode (e.g., to enter a cursor control mode), a power-saving mode, a sampling rate for one or more sensors, etc.

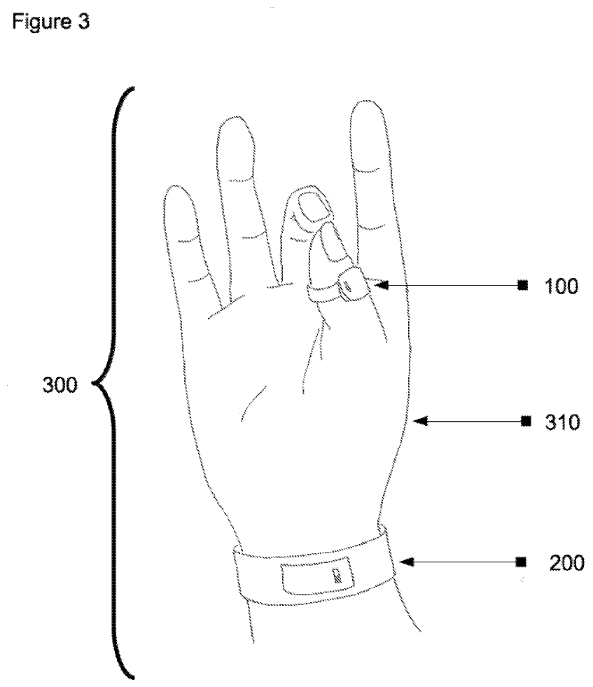

Referring to FIG. 3, an interface 300 may include multiple components worn on different parts of a user's hands or arms. In the example depicted in FIG. 3, the interface includes a ring 100 and a bracelet 200 worn on the same hand 310. Once the interface is in place on a user's wrist and thumb, a position tracker module may be initialized. In some implementations, the position of the sensors in both the ring and the bracelet are tracked by integrating the dynamic motion detected by both components. The change in position experienced by the bracelet serves as reference for determining how the position of the thumb has changed in relationship to the rest of the hand. In this manner the effects of unrelated user movement, such as turning, sitting, standing, walking or riding in a vehicle, on the position of the thumb may be controlled for to isolate changes in the position of the thumb relative to the rest of the hand.

In some implementations, accelerometer readings are sampled at a frequency of about 1 kHz and the resulting digital signals are processed to detect when thumb taps occur and classify taps according to the tap targets that are hit. All or part of the processing may be performed by a microprocessor located on the ring or the bracelet. All or part of the processing of accelerometer readings may be performed on a data processing device that receives readings via a radio frequency transmission from the transmitters on the ring and/or on the bracelet. The data processing device may be an internal or external processing device, such as a cellphone, that runs software configured to receive sensor readings or information (e.g., filtered signals and/or symbols) based on those readings from the interface. Alternatively the processing device may be a stand-alone device configured to receive information based on sensor readings from the interface via the radio frequency transmission. The stand-alone processing device may in turn pass information such as detected target tap events to an external processing device, such as a computer, via another interface, such as a USB (Universal Serial Bus) port.

In some implementations, the devices in the interface system may communicate with each other by means of radio frequency. For example, low-power wireless transmission from a ring with a short range (e.g., 1 foot range) may be used to convey measurement from the sensors of the ring to a processing device attached to a bracelet, which may in turn interpret those measurements and/or forward they to a target computing device via a higher power wireless communications link (e.g., a Bluetooth link). Such a configuration may allow a smaller battery to be included in the ring than in the bracelet. In some implementations, they may communicate with each other through wired connections. For example, the ring 100 and bracelet 200 may communicate sensor readings through wired connections to determine their individual spatial orientations. As another example, the bracelet may hold an energy storage that supplies power to the ring through the wire connections.

Accelerometers in the wristband may also be used to detect the spatial orientation of the hand by measuring the static acceleration caused by the gravitational pull of the Earth, which is a vector along the Earth radius, extending from the Earth center through the wearer of the interface. The orientation of the accelerometer to the user's wrist may be fixed by the wristband. Thus, the axes of the three dimensions sensed by the accelerometers may be fixed with respect to the orientation of the user's wrist. The angle of the Earth-radius vector with respect to the reference frame extended by the axes is calculated to determine the orientation of the wrist with respect to the Earth radius. Similarly, the angle of the Earth-radius vector with respect to the reference frame extended by the axes of the ring accelerometers is calculated to determine the angle of a phalanx of the thumb with respect to the Earth radius.

The Earth-radius angles of the thumb and wrist may be compared to estimate a component of the angle between the thumb and the wrist outside of the plane orthogonal to the Earth radius. The angle between the thumb and the wrist at the time that a tap is detected may be used to distinguish tap targets on the hand. Information about the current angle between the thumb and the wrist may be used in conjunction with information from a position tracking module to classify tap events by assigning them to a tap target.

In some implementations, magnetometers may be used in conjunction with accelerometers to to determine the relative orientations of the thumb ring and a reference device, such as a reference device located on the wrist. The thumb ring may include a tri-axial accelerometer and a tri-axial magnetometer. The axes of these magnetometer and the accelerometer may be aligned. The reference device may also include an accelerometer and a magnetometer whose axes are aligned. When a tap event is detected, readings from the thumb sensors and the references sensors are windowed and sampled to estimate the acceleration and magnetic field experienced by the thumb sensors and the reference sensors while the thumb is at rest relative to the rest of the hand during a tap event. These estimates are encoded as four 3-dimensional vectors: tₐ, tₘ, rₐ, rₘ. For the ensuing disclosure, we use the following notations:

rₘ: The magnetic flux vector detected by the magnetometer in the reference device.

rₐ: The acceleration vector detected by the accelerometer in the reference device.

tₘ: The magnetic flux vector detected by the magnetometer in the thumb device.

tₐ: The acceleration vector detected by the accelerometer in the thumb device.

x^{t}: The x component of the vector ^{t} and similarly for the y and z components.

Rₘ: The rotation matrix for aligning the magnetic flux vectors.

Rₐ: The rotation matrix for aligning the acceleration vectors.

R : The rotation matrix for aligning both the magnetic flux and acceleration vectors.

A rotation that represents the relative orientation of the thumb device and the reference device during the tap event may be determined from those four vectors. That rotation may be determined in stages by first determining two component rotations, Rₘ and Rₐ, and then combining them. First a rotation that aligns the two magnetic field vectors is calculated by taking a cross product of rₘ and tₘ to determine the axis of a minimum-angle rotation that aligns the two vectors as well as the magnitude of the angle of rotation. A dot product is also calculated to disambiguate the quadrant of the angle. These calculations yield an axis/angle representation of the first component rotation.

$${x}_{m} = \frac{{t}_{m} \times {r}_{m}}{‖ {t}_{m} ‖ ‖ {r}_{m} ‖} Eq 1 \text{:} Cross product of magnetic field vectors$$

$${s}_{m} = {sin }_{m} = ‖ {x}_{m} ‖ Eq 2 \text{:} The sine of the angle of rotation$$

$${c}_{m} = {cos }_{m} = \frac{{t}_{m} {r}_{m}}{‖ {t}_{m} ‖ ‖ {r}_{m} ‖} Eq 3 \text{:} The cosine of the angle of rotation$$

$${n}_{m} = \frac{{x}_{m}}{‖ {x}_{m} ‖} = \frac{{x}_{m}}{{sin }_{m}} Eq 4 \text{:} The normalized axis of rotation$$

The first component rotation can be computed from the rotation axis and the rotation angle. Let cₘ=1-cₘ. The first component rotation is represented by a 3×3 matrix, Rₘ:

$${R}_{m} = [ \begin{matrix}{}_{x}^{ }{n}{}_{m}^{2} {c}_{m} {c}_{m} & {}_{x}^{ }{n}{}_{m}^{} {}_{y}^{ }{n}{}_{m}^{ } {c}_{m} - {}_{z}^{ }{n}{}_{m}^{ } {s}_{m} & {}_{x}^{ }{n}{}_{m}^{} {}_{z}^{ }{n}{}_{m}^{ } {c}_{m} {}_{y}^{ }{n}{}_{m}^{ } {s}_{m} \\ {}_{y}^{ }{n}{}_{m}^{} {}_{x}^{ }{n}{}_{m}^{ } {c}_{m} {}_{z}^{ }{n}{}_{m}^{ } {s}_{m} & {}_{y}^{ }{n}{}_{m}^{2} {c}_{m} {c}_{m} & {}_{y}^{ }{n}{}_{m}^{} {}_{z}^{ }{n}{}_{m}^{ } {c}_{m} - {}_{x}^{ }{n}{}_{m}^{ } {s}_{m} \\ {}_{z}^{ }{n}{}_{m}^{} {}_{x}^{ }{n}{}_{m}^{ } {c}_{m} - {}_{y}^{ }{n}{}_{m}^{ } {s}_{m} & {}_{z}^{ }{n}{}_{m}^{} {}_{y}^{ }{n}{}_{m}^{ } {c}_{m} {}_{x}^{ }{n}{}_{m}^{ } {s}_{m} & {}_{z}^{ }{n}{}_{m}^{2} {c}_{m} {c}_{m}\end{matrix} ] Eq 5 \text{:} Rotation matrix for magnet field vectors$$

The first rotation matrix is then applied to the thumb acceleration vector, tₐ, to determined the rotated thumb acceleration vector, tₐ.

tₐ=32 Rₘtₐ Eq 6: Rotated thumb acceleration vector

A second component rotation that aligns tₐ with the reference acceleration,rₐ, may be determined next. The second component rotation may be constrained to use an axis of rotation aligned with the reference magnetic field, rₘ, so that alignment of the two magnetic field vectors is preserved by the second component rotation. That can be done, for example, using the projections of rₐ and tₐ onto the plane perpendicular to rₘ.

$$Eq 7 : Projection of reference acceleration vector$$

$${p}_{r} = {r}_{a} - {r}_{a} \frac{{r}_{m}}{‖ {r}_{m} ‖} \frac{{r}_{m}}{‖ {r}_{m} ‖}$$

$$Eq 8 : Normalized projection vector$$

$${p}_{r}^{n} = \frac{{p}_{r}}{‖ {p}_{r} ‖}$$

$$Eq 9 : Projection of thumb acceleration vector$$

$${p}_{t} = {t}_{a} - {t}_{a} \frac{{r}_{m}}{‖ {r}_{m} ‖} \frac{{r}_{m}}{‖ {r}_{m} ‖}$$

$$Eq 10 : Normalized projection vector$$

$${p}_{t}^{n} = \frac{{p}_{t}}{‖ {p}_{t} ‖}$$

The minimum angle rotation to align these projections will then have an axis of rotation parallel to rₘ, so a cross product and dot product may be applied to the projections to determine the angle of rotation in this plane that will align the projections of the acceleration vectors. This second component rotation may also be computed from an axis/angle representation and may be represented as a matrix, Rₐ.

xₐ=pₜⁿ×pᵣⁿ Eq 11: Cross product of projected acceleration vectors

$$Eq 12 : The sine of the angle of rotation$$

$${s}_{a} = {sin}_{a} = ‖ {x}_{a} ‖$$

$$Eq 13 : The cosine of the angle of rotation$$

$${c}_{a} {cos}_{a} = {p}_{t}^{n} {p}_{r}^{n}$$

$$Eq 14 : The normalized axis of rotation$$

$${n}_{a} = \frac{{x}_{a}}{‖ {x}_{a} ‖} = \frac{{x}_{a}}{{sin}_{a}}$$

$$Eq 15 : Rotation matrix for magnet field vectors$$

$${R}_{a} = [ \begin{matrix}{}_{x}^{}{n}{}_{a}^{2} {c}_{a} {c}_{a} & {}_{x}^{}{n}{}_{a}^{} {}_{y}^{}{n}{}_{a}^{} {c}_{a} - {}_{z}^{}{n}{}_{a}^{} {s}_{a} & {}_{x}^{}{n}{}_{a}^{} {}_{z}^{}{n}{}_{a}^{} {c}_{a} {}_{y}^{}{n}{}_{a}^{} {s}_{a} \\ {}_{y}^{}{n}{}_{a}^{} {}_{x}^{}{n}{}_{a}^{} {c}_{a} {}_{z}^{}{n}{}_{a}^{} {s}_{a} & {}_{y}^{}{n}{}_{a}^{2} {c}_{a} {c}_{a} & {}_{y}^{}{n}{}_{a}^{} {}_{z}^{}{n}{}_{a}^{} {c}_{a} - {}_{x}^{}{n}{}_{a}^{} {s}_{a} \\ {}_{z}^{}{n}{}_{a}^{} {}_{x}^{}{n}{}_{a}^{} {c}_{a} - {}_{y}^{}{n}{}_{a}^{} {s}_{a} & {}_{z}^{}{n}{}_{a}^{} {}_{y}^{}{n}{}_{a}^{} {c}_{a} {}_{x}^{}{n}{}_{a}^{} {s}_{a} & {}_{z}^{}{n}{}_{a}^{2} {c}_{a} {c}_{a}\end{matrix} ]$$

The two component rotations may then be combined by multiplying the two matrices in the proper order to produce a matrix representation of the relative orientation of the two devices, R.

R=RₐRₘ Eq 16: Complete rotation matrix

The relative orientation of the thumb and reference devices may be converted from the matrix representation to a lower dimensional representation to enable more efficient slicing to quantize the orientation estimate into a symbol estimate. For example, the matrix representation, R, may be converted to an axis/angle representation using an eigenvalue decomposition. Since the axis of the rotation is a unit vector, the axis/angle may be expressed as a three-tuple by multiplying the axis by the angle of rotation. These three-tuples may then be assigned to symbol estimates by slicing in the three dimensional space.

A slicer for the orientation estimates may be generated using standard techniques applied to corpus of tap orientation measurements taken during a known tap sequence. For example the centroids of clusters of orientation estimates corresponding to a particular tap may be used. Slicing may be accomplished by determining the nearest tap centroid to a new orientation estimate. Slicer regions may be determined based on aggregated data for many users or for a particular user by using training sequences to collect data from that user. In some cases an abbreviated training sequence may be used to customize generic slicer regions to a particular user.

The order of the decomposition of the orientation rotation into components may be reversed. For example, the component required to align the acceleration vectors may be determined first and then a constrained component rotation to approximately align the magnetic field vectors may be subsequently determined and then combined. The selection of the order in which the decomposition is performed may be informed by the signal-to-noise ratios (SNRs) experienced by the accelerometers and the magnetometers.

A calibration sequence may be performed by a user before the first use of the interface. The user may be prompted to execute each step of the calibration process using a display connected to a processing device that the interface is inputting data to. The prompt instructs the user to touch one or more of the targets on the hand and data is recorded as taps are detected. The data may be used only for the current session, or stored in memory as a user profile. In this manner, the interface may be trained to respond to the geometry of the hand and tendencies of a particular user.

In some implementations ring 100 may include a thermometer that is used to dynamically adjust an output amplifier gain for one or more of the sensors (e.g., an accelerometer) that have a response characteristics that vary with temperature.

In some implementations, not depicted, one or more accelerometers located in a second ring worn on one of the proximal phalanges of the other fingers on the hand may be used as a reference for determining position and angles of the thumb in relation to the rest of the hand.

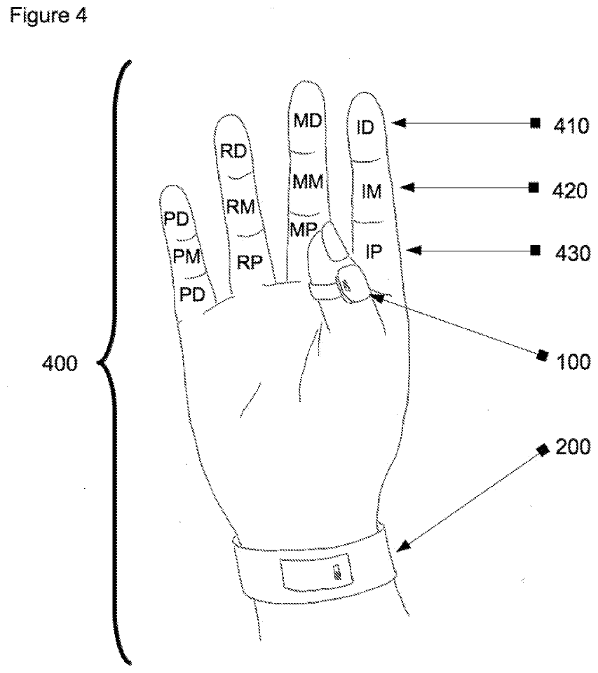

Referring to FIG. 4, in some implementations, tap targets are located on phalanges of fingers of a user's hand that the user may ergonomically tap with the thumb while wearing an example interface including ring 100 and bracelet 200. An example layout 400 of tap targets on the hand is shown in FIG. 4. For each of the four other fingers on the hand, the tap targets are centered on the inside surface of the distal 410, middle 420, and proximal 430 phalanges. A mapping is established that assigns different symbols to taps of each of the targets. In the figure, each target is labeled by an associated symbol. In some implementations (not shown), the tap targets on an index finger may be centered on the side of the index finger closest to the thumb. Locating tap targets on the fingers of the user may allow a user to conduct taps without looking at the tap targets.

An interface may include a matching set of components for the other hand so that both hands may be used for data entry. In this case different symbols may be assigned to the corresponding tap targets on each hand to double the size of the symbol set. Furthermore, taps on both hands may be combined to expand the symbol set even more. For example, tapping and holding the distal phalanx of the left index finger while tapping the phalanges on the other hand may be mapped to one set of symbols; tapping and holding the medial phalanx of the left index finger while tapping the phalanges on the other hand may be mapped to another set of symbols. In this way, at least 144 (12 phalanges on the left hand times 12 phalanges on the right hand) symbols may be produced from combining the taps on the two hands.

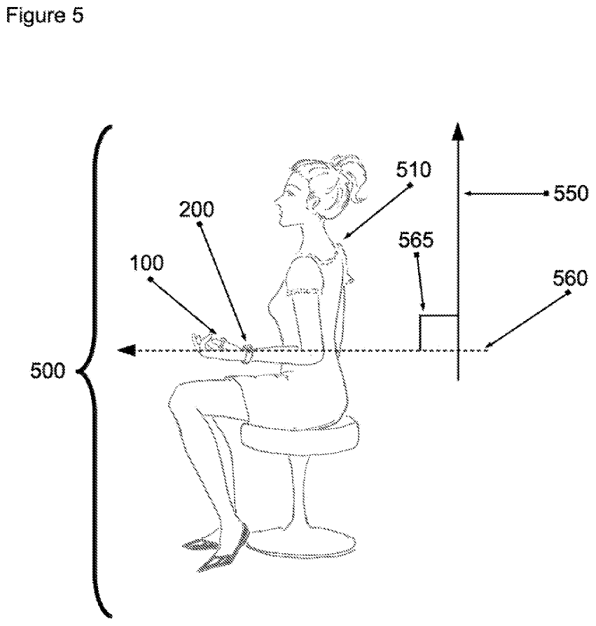

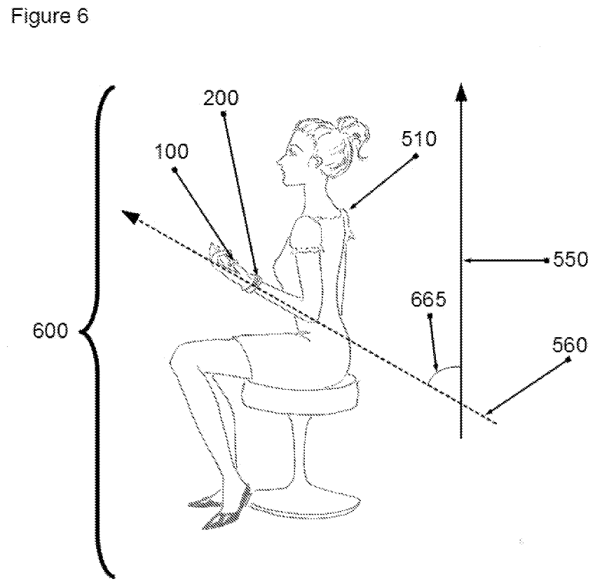

Referring to FIG. 5 and FIG. 6, the angle of the wrist to the Earth radius may be used to distinguish multiple symbols assigned to a single tap target. In example usage scenarios 500 and 600, one of the three axes, the z-axis 560, of the accelerometers in the bracelet 200 is approximately parallel to the forearm of the user 510 and the other two axes are labeled x and y. The angle 565 of the z-axis to the Earth radius 550 may be determined and compared to thresholds to distinguish multiple sets of symbols assigned to the targets on a hand. FIG. 5 shows a user 510 wearing an interface including a ring 100 and a bracelet 200 with the forearm oriented at approximately ninety degrees to the Earth radius 550. In this position, the user 510 is able to input one set of symbols by tapping the targets on the hand with the thumb. The user 510 may access other symbols in scenario 600 by bending the elbow to, for example, raise the forearm to an angle 665 of approximately fifty degrees to the Earth Radius 550, as depicted in FIG. 6. In this position, the user 510 may input a second set of symbols by tapping the same targets on the hand. In this manner the multiple symbol sets may be assigned to different ranges of the angle between the user's forearm and the Earth radius.

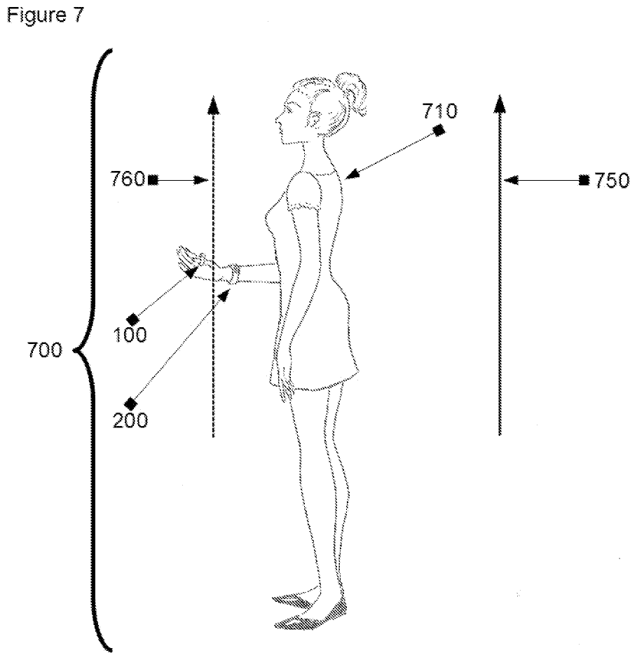

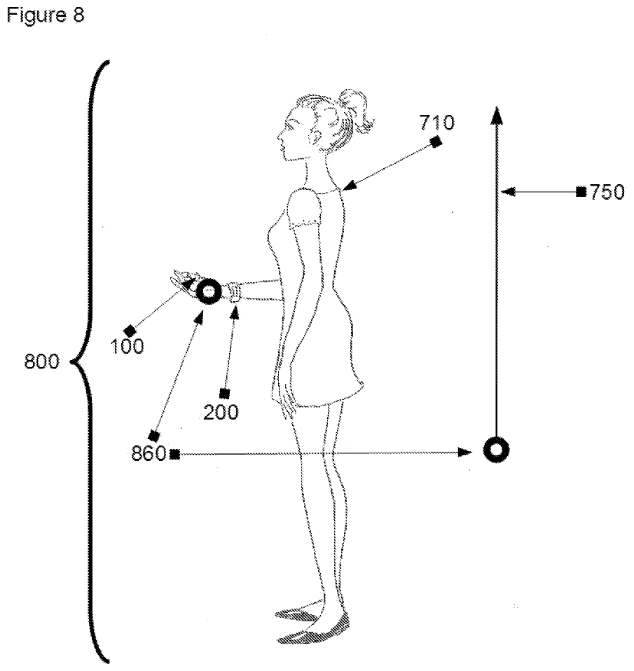

Referring to FIG. 7 and FIG. 8, more sets of symbols may be distinguished by detecting rotations of the wrist. For example, in usage scenario 700, one position for data entry may be with the user's wrist turned so the palm of the hand faces up, as depicted by the direction of the dashed arrow 760 in FIG. 7. An axis (e.g., an x-axis) of an accelerometer in bracelet 200 may be approximately parallel to line 760 which is perpendicular to the surface of the palm of user 710. The angle of this axis and/or the angle of a second axis that is also approximately orthogonal to a line parallel to the length of the user's forearm with an acceleration experienced by the accelerometer during a tap may be determined and used estimate the orientation of the user's wrist with respect to the Earth Radius 750. In this manner it can be determined that the palm of user 710 is facing up and a certain set of symbols may be assigned to tap targets on the hand. Usage scenario 800 shows another data entry position, in which the wrist is rotated so that the palm faces to the side, as depicted in FIG. 8. The dark circles 860 illustrate an axis (e.g., an x-axis) of an accelerometer in the bracelet 200 that points out of the page. In this scenario 800, the axis 860 that is approximately perpendicular to the surface of the palm is also perpendicular to the Earth Radius 750, while another axis that is also approximately perpendicular to the length of the user's forearm is approximately parallel with the Earth Radius 750. As long as the forearm is not parallel to the Earth radius, these wrist rotation positions may be distinguished by comparing the angle between the x or y axes of the accelerometers in the bracelet and the Earth radius to thresholds. In this manner the number of wrist twist positions distinguished can further multiply the number of symbols that may be signaled with the interface.

In some implementations, wrist twists may be detected by tracking fast changes in position of accelerometers of an interface. For example, the thumb-up and thumb-down gestures, may be detected for signaling approval (OK) and disapproval (CANCEL), respectively, selections in computer user interface and interaction (UI and UX).

Wrist orientations may also be used to enter different input modes for an interface. For example, turning the wrist so that the palm faces down could be used to enter a cursor control mode. In cursor control mode, the hand may be moved in the three dimensional space in front of the user to control a cursor in one or more dimensions. Thumb orientation in relation to the reference frame on the wrist may be used to determine whether the cursor is engaged or not, so that the cursor can continue to be moved in a direction beyond the reach of the user, much like a user may pick up a mouse or disengage the finger from a trackball. For example, the cursor may be disengaged when the thumb is oriented approximately perpendicular to the length of the forearm of the user (e.g., held in a thumb-up gesture) and the cursor may be engaged when the thumb is closer to parallel with the length of the forearm. For example, an angle between an axis of a sensor attached to the thumb that is approximately parallel to a portion of the thumb and an axis of a senor attached to the wrist that is approximately parallel to the forearm may be estimated to determine whether the cursor is engaged. Tap targets may be assigned different symbols in such a mode. For example, a tap target may be tapped to select or deselect item highlighted by a cursor.

In implementations of an interface that use two thumb rings, certain tap targets may be assigned meta symbols (e.g., ‘shift’ or ‘ctrl’) that change the interpretation of target taps by one thumb while the other thumb is held in place on the meta symbol target.

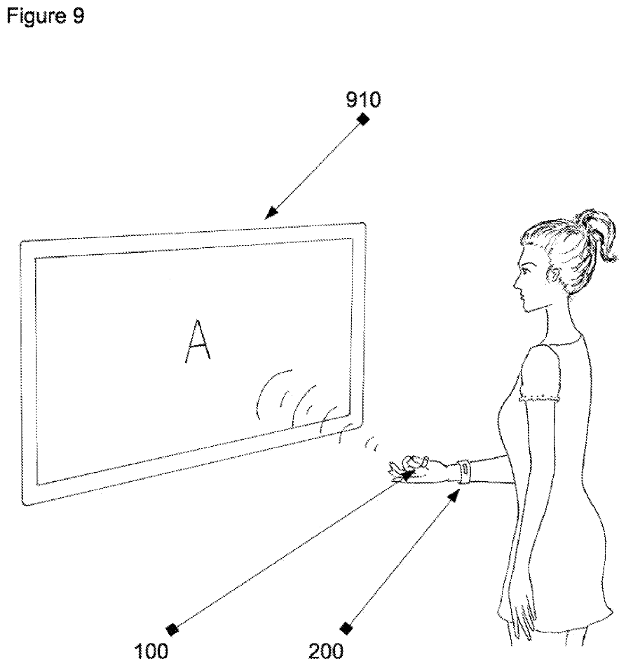

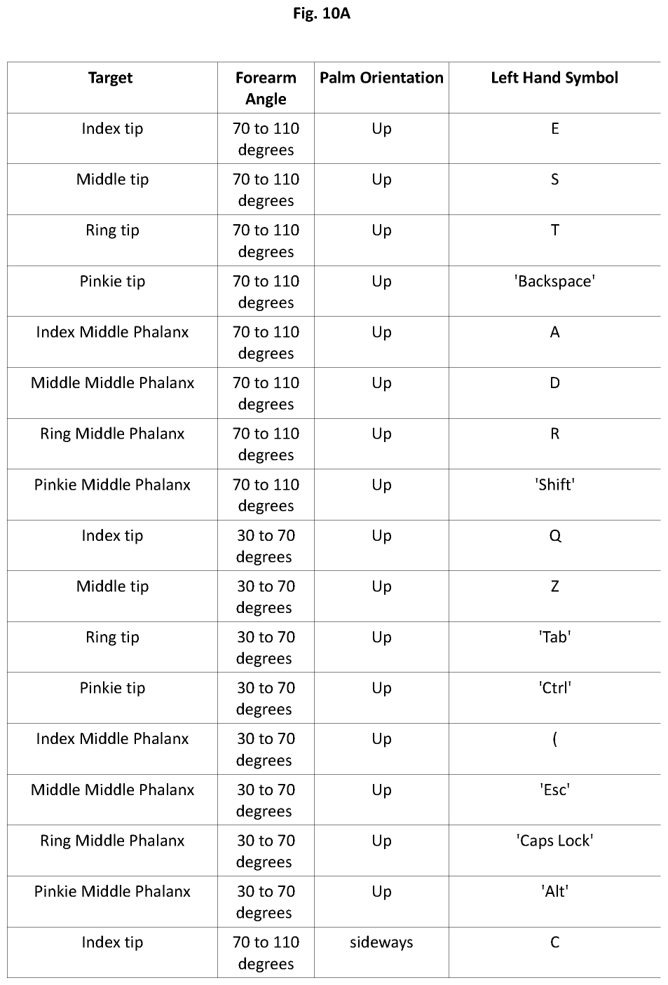

Referring to FIG. 9, user input received through an interface may be processed and/or used by a computing device in a variety of ways. One way, is to present graphical representations of symbols indicated by the user gestures (e.g., thumb taps) made while wearing an interface. FIG. 9 illustrates an example interface system in which a user wearing an interface including a ring 100 and a bracelet 200 performs a thumb tap to cause a combined processing and display device 910 (e.g., a Bluetooth enabled internet television) to display an alpha-numeric character associated with the thumb tap gesture. It should be noted that this is just one of many possible computing devices that may be controlled using this type of computing interface. For example, an interface (e.g., including ring 100 and bracelet 200) could be used to input data to a smartphone with an touchscreen display, a tablet device with a touchscreen display, a computing device controlling a projector, a computing device controlling other actuators (e.g., an environmental control system in an automobile), among many other computing devices.

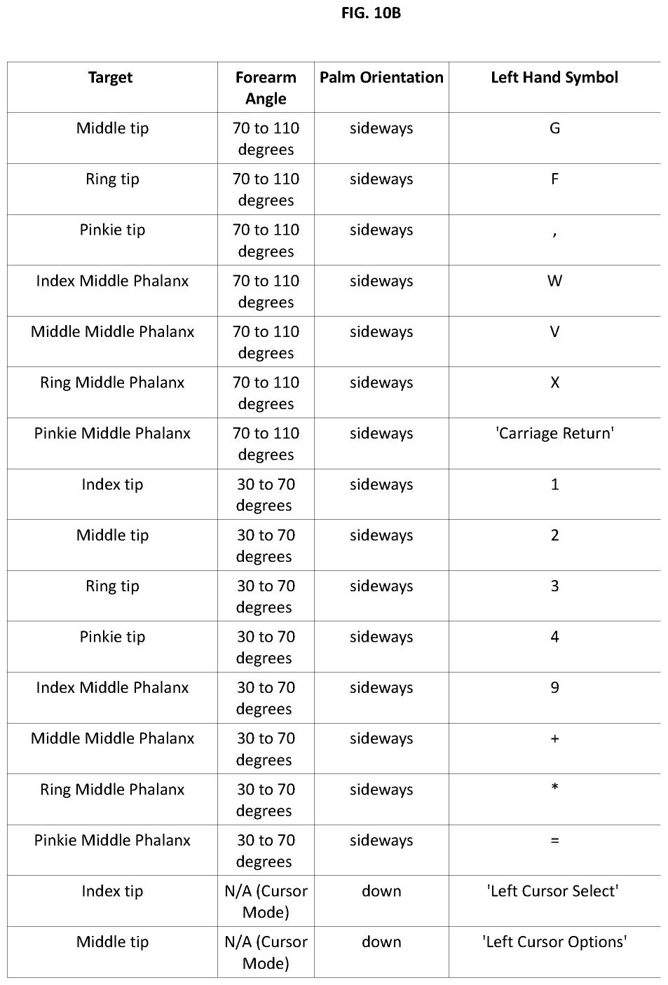

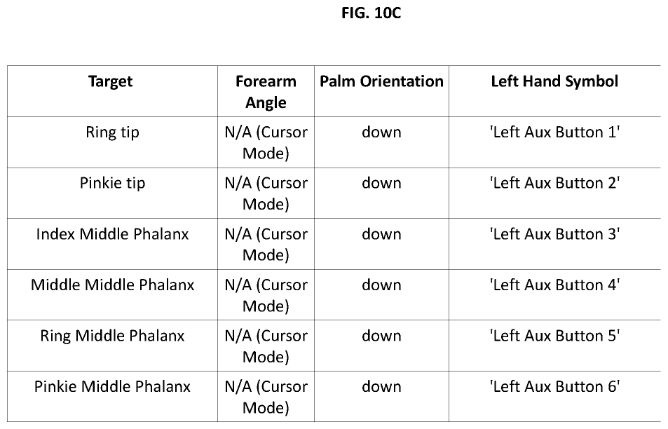

Referring to FIGS. 10A-10C, by combining some of these methods of distinguishing symbols by detecting taps of targets on the hand and the concurrent orientation of the hand, an interface may be used to distinguish a large number of symbols. An example table that maps tap targets and hand orientations to symbols is depicted in FIGS. 10A-10C.

The mapping of tap targets to symbols may be memorized by the user. As needed, the mapping of symbols to targets may be depicted on the hand by wearing a thin glove with the symbols drawn on positions associated with their targets. The mapping may also be displayed to the user by illustrating the symbols on their tap targets on the image of a hand on a display controlled by the external processing device that data is being entered into. The image of the hand(s) with marked targets may be semi-transparent, overlaying the user interface of the underlying application. Such a display could be enabled, disabled or minimized when not needed by entering a special “help” symbol.

The mapping of targets to symbols may be designed by analyzing the relative frequency of symbols used. For example statistical analysis of a collection of texts may be conducted to determine which letters and letter sequences are most commonly used. The most commonly occurring symbols may then be mapped to targets located close together and in the positions that are most easily accessible to the thumbs. Common sequences of symbols may have all their symbols assigned to targets that may be tapped in quick succession. In this manner, an interface may be optimized for particular languages or applications. The mapping of tap targets to events may be custom-configured by the users.

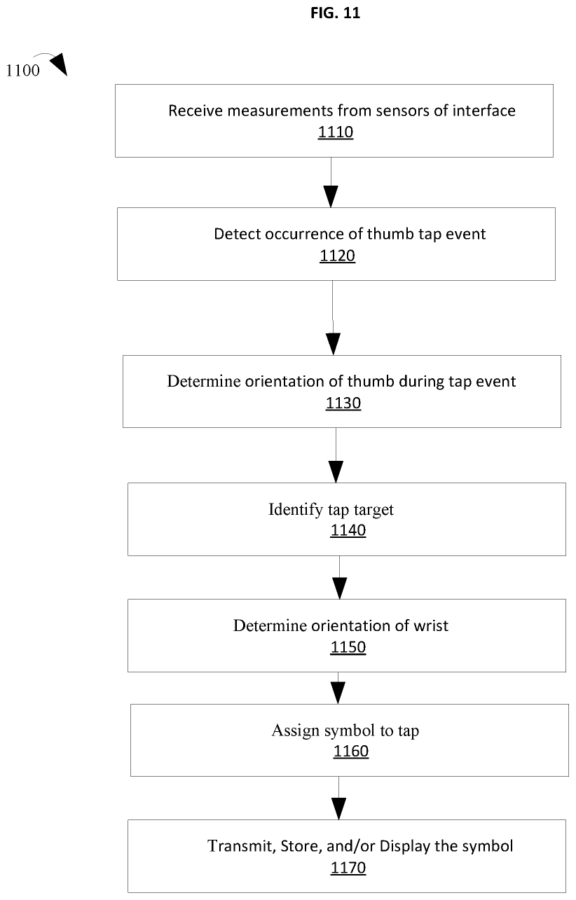

FIG. 11 is a flowchart of an example process 1100 for interpreting signals from a user computing interface. In some implementations, the process 1100 may be performed by executing driver software for the computing interface on a computing device (e.g., a smart-phone, a tablet device, laptop computer, automobile environmental control system, or a television) that a user seeks to control by making hand gestures while wearing the computing interface. A computing device may include a microprocessor and a data storage device (e.g., flash memory) storing instructions for causing the computing device to perform process 1100. In some implementations, the process 1100 may be performed by a data processing device (e.g., a micro-controller or microprocessor) attached to the wrist of a user and symbols derived from the signal processing may be transmitted to a computing device that the user seeks to control. In some implementations, a data storage device (e.g., flash memory) storing instructions that cause a data processing device to perform process 1100 may also be attached to the wrist.

The process 1100 may begin by receiving 1110 measurements from sensors of the interface. The measurements may include acceleration measurements from an accelerometer that is attached to a thumb of a user. In some implementations, the measurements also include acceleration measurements from a second accelerometer that is attached to a wrist of the user. In some implementations, the measurements also include magnetic flux measurements from a magnetometer that is attached to the thumb of the user and magnetic flux measurements from a magnetometer that is attached to the wrist of the user. In some implementations, the measurements also include angular rate measurements from a gyroscope that is attached to the thumb of the user and angular rate measurements from a gyroscope that is attached to the wrist of the user.

The measurements from the sensors may be received as a time series of samples (e.g., sampled at 250 Hz, 500 Hz, 1 KHz, or 2 KHz) from each sensor output. For example, one or more sensors may be sampled using a co-located micro-controller and resulting samples may be transmitted through one or more communications links (e.g., Bluetooth wireless links and/or a serial port link) to processing device for further analysis. In some implementations, the time series of samples for each sensor is time synchronized with the time series of samples for a reference sensor (e.g., the accelerometer attached to the thumb or to the accelerometer attached to the wrist may dictate timing for the other sensor signals). For example, a phase locked loop (PLL) may be implemented to compensate for clock skew and maintain synchronization with a reference signal from a sensor that is sampled with different clock. A processing device receiving the measurements from the sensors may operate as a master in a master-slave configuration to enforce a sample timing for measurements received from multiple sensor modules of the interface. In some implementations, a training sequence that causes simultaneous excitations in two sensors may be used to establish an initial phase synchronization between the signals from the two sensors. For example, an arm on which accelerometers are worn on the thumb and the wrist may be swung at the shoulder joint to induce an approximately simultaneous change in quantities measured by sensors at both locations on the arm. In some implementations, the measurements from two different sensors of the interface may be received asynchronously. For example, sensors worn on the right and left hands may be received asynchronously.

In some implementations, the measurements may have been filtered or otherwise processed prior to receiving 1110 the measurements for the sensors. For example, a sequence samples of measurements from an accelerometer and a co-located gyroscope may be filtered and/or converted to a sequence of measurements of an orientation (e.g., encoded as Euler angles or a quaternion representation) of the co-located sensors by a co-located micro-controller before the measurements are received 1110 by an external processing device.

For example, the measurements from the sensors of the interface may be received 1110 through a wireless network interface (e.g., a Bluetooth interface) of a processing device that will interpret the measurements. In some implementations, the measurements may be received by a processing device that is co-located with some of the sensors of the interface (e.g., attached to the wrist of the user). In these implementations, the measurements from co-located sensors may be received 1110 through a bus or other short range data transfer channel while measurements from sensors located further from the processing device may be received 1110 through a wireless communication channel (e.g., a Bluetooth link) or though a two or more wires (e.g., a serial port cable) connecting sensor modules of the interface.

A tap of the thumb on a surface may be detected 1120 as an event based on the received sensor measurements. In some implementations, a tap event may be detected by filtering a sequence of acceleration measurements and/or angular rate measurements from an accelerometer and/or a gyroscope attached to the thumb of the user. Large fast changes in these measurements may be associated with a tap event. For example, the difference between consecutive samples of these measurements may be compared to a threshold (e.g., 1.2 times the acceleration due to Earth's gravity for the linear acceleration) and when the threshold is exceeded a tap event may be detected 1120. A tap detection module may also implement debouncing logic to ignore fast changes in these measurements for a short configurable period of time (e.g. 10 or 20 milliseconds) after a tap is detected. For example, tap events may be detected 1120 by a tap detection module of device driver running on a computing device. In some implementations, tap events may be detected 1120 by a tap detection module running on a processing device that is attached to the wrist of the user.

An orientation of the thumb during the tap event may be determined 1130. When a tap of the thumb is detected, signals (e.g., sequences of measurements) from sensors of the interface may be windowed and/or otherwise filtered in the neighborhood of the detected tap event to estimate characteristics of the tap event. For example, a window of sensor measurements (e.g., a 5, 10, or 20 millisecond long window) just after a large deceleration associated with the onset of a tap event may be averaged to estimate characteristics of the tap event during a brief period while the thumb is at rest (relative to the rest of the hand) and in contact with a tap target. In some implementations, the deceleration associated with the impact is itself considered as a characteristic of the tap event. For example, acceleration measurements from an accelerometer attached to the thumb may be filtered to determine an estimate of a deceleration vector caused by the impact of the thumb with the tap target. The orientation of the estimated deceleration vector relative to the axes of one or more sensors attached to the thumb may be a characteristic considered for classification of a tap event.

In some implementations, an orientation of one or more sensors attached to the thumb of the user is determined 1130 relative to the an orientation of one or more sensors attached to the wrist of the user. For example, an estimate of the acceleration experienced by an accelerometer attached to the thumb while the thumb was at rest on the tap target (e.g., acceleration due to the Earth's gravitational force, the acceleration of a vehicle the user is riding in, and/or other exogenous forces) may be compared to an estimate of the acceleration experienced by an accelerometer attached to the wrist of the user during the same period of time (e.g., a time window just after the deceleration marking the start of the tap event) to compare the relative orientations of these accelerations as experienced at each location on the hand or arm of the user. These estimates of acceleration may be determined based in part on acceleration measurements from the respective accelerometers attached to the thumb and the wrist or some other reference location.

In some implementations, the relative orientation of the thumb and the wrist is determined 1130 based in part on magnetic flux measurements from a magnetometer attached to the thumb and magnetic flux measurements from a magnetometer attached to the wrist. For example, an estimate of the magnetic flux experienced by the magnetometer attached to the thumb while the thumb was at rest on the tap target (e.g., due to the Earth's magnetic field, magnetic field from a nearby transformer or power line, and/or other sources of magnetic flux) may be compared to an estimate of the magnetic flux experienced by the magnetometer attached to the wrist of the user during the same period of time (e.g., a time window just after the deceleration marking the start of the tap event) to compare the relative orientations of these magnetic flux vectors as experienced at each location on the hand or arm of the user. Where the magnetic flux is approximately uniform in the region of space around the thumb and wrist locations, the orientations of the magnetic flux vectors, as experienced by the respective magnetometers, may provide information about the relative orientation of the two sensors.

In some implementations, an orientation of the thumb relative to the wrist may be determined 1130 by combining information about the acceleration and magnetic flux experienced at the two locations. For example, as described above in relation to Equations 1 through 16, a rotation that approximately aligns the acceleration vectors and the magnetic flux vectors estimated for the two locations may be determined that specifies an estimated orientation of the thumb relative to the wrist. The estimates of the accelerations and magnetic flux experienced at each location may be determined by filtering measurements from the respective accelerometers and magnetometers at the locations. For example, the measurements for each sensor may be similarly windowed and averaged (e.g., by applying a Hamming window lagged with respect to a large deceleration that triggered the tap event) in a period corresponding to the thumb being at rest relative to the rest of the hand on the tap target.

In some implementations, an orientation of the thumb relative to the wrist is determined 1130 based in part on angular rate measurements from a gyroscope attached to the thumb and angular rate measurements from a gyroscope attached to the wrist. The angular rate measurements from the gyroscope attached to the thumb may be integrated over a period of time ending during the detected tap event to determine an estimate of an orientation of the thumb during the tap event with respect to a reference position (e.g., a rest position of the thumb). The angular rate measurements from the gyroscope attached to the wrist may be integrated over the same period of time ending during the detected tap event to determine an estimate of an orientation of the wrist during the tap event with respect to a reference position corresponding to the reference position for the thumb. In some implementations, the reference positions for the thumb and wrist may be synchronously reset periodically (e.g., every minute) or upon prompting from a user. The estimate of orientation of the thumb may be compared to the estimate of the orientation of the wrist to determine 1130 an orientation of the thumb relative to the wrist at a time associated with the tap event. For example, a rotation may be determined that relates to the two respective estimates of orientation.

In some implementations, an orientation of the thumb relative to the wrist may be determined 1130 by combining information about the linear acceleration and angular rate experienced at the two locations. For example, acceleration and angular rate measurements for the thumb may be integrated over a period of time that ends during the tap event to determine an estimate of the position and/or orientation of the thumb during the tap event. Similarly, acceleration and angular rate measurements for the wrist may be integrated over the same period of time to determine an estimate of a position and/or orientation of the wrist during the tap event. The position and/or orientation estimates for the thumb and wrist may be compared to determine 1130 a orientation of the thumb relative to the wrist. For example, a rotation may be determined that relates to the two respective estimates of orientation and a displacement vector may be determined that relates the two estimates respective estimates of position.

For example, an orientation of the thumb may be determined 1130 by a tap classification module of device driver running on a computing device. In some implementations, an orientation of the thumb may be determined 1130 by a tap classification module running on a processing device that is attached to the wrist of the user.

A tap target that was touched during a tap event is identified 1140. A set of characteristics of the tap event may be analyzed to identify 1140 which tap target from among a set of configured tap targets has been tapped by the thumb of the user. For example, the tap targets may be configured to be located on other fingers of the user (e.g., as described in relation to FIG. 4). The characteristics of a tap event may be represented as a vector in a feature space and the tap targets may be configured by partitioning the feature space into regions associated with one or none of the tap targets.

In some implementations, the tap characteristics include an orientation of the thumb (e.g., represented as a quaternion, a Euler angles triple, or an angle weighted axis of rotation). For example, the feature space for orientations may be a three-dimensional or four-dimensional space. In some implementations, the tap characteristics include a displacement vector describing the position of the thumb relative to the wrist. In some implementations, the tap characteristics include an estimate of a deceleration vector associated with the impact of the thumb on the tap target. In some implementations, different characteristics of the tap may be combined to form a larger vector in a higher dimensional feature space. For example, feature vector may include elements of a quaternion representation of a thumb orientation and a three element representation of a displacement vector describing the position of the thumb relative to the wrist. In this case, the feature space may have seven dimensions.

The feature space may have been previously partitioned based on training data associated with each configured tap target location. For example, the partition may be determined using a nearest neighbor rule applied to a set of cluster centroids for each tap target. In some implementations, the feature space is partitioned based on training data for a large group of users. In some implementations, the feature space is partitioned based on training data for a particular user. The partition of the feature space may implemented as slicer that maps orientation data to an identification of one of the configured tap targets or an error/ignore result.

For example, a tap target may be identified 1140 by a tap classification module of device driver running on a computing device. In some implementations, a tap target may be identified 1140 by a tap classification module running on a processing device that is attached to the wrist of the user.

An orientation of the wrist is determined 1150. In some implementations, an orientation of the wrist relative to the Earth's gravitational field is used to distinguish between multiple symbols associated with a tap target. An estimate of an orientation of an acceleration experienced by the accelerometer attached to the wrist with respect to the axes of that accelerometer during the tap event may be determined based on acceleration measurements from that accelerometer. The acceleration experienced at the wrist during a tap event may be dominated by acceleration caused by the gravitational force of the Earth. For example, measurements from the accelerometer attached to the wrist may be windowed and averaged in a time period corresponding to the tap event to determine an estimate of the acceleration due to gravity as a vector represented in the basis of the axes of the accelerometer. Estimates of angles between this gravity vector and the axes of the accelerometer may be determined as needed to classify the orientation of the wrist with respect to the gravity vector. For example, one axis of the accelerometer may be assumed to be approximately parallel to the forearm of the user when the user wears the interface, while the other two axes are perpendicular to the first axis.

In some implementations, an orientation of the wrist relative to a magnetic field (e.g., the Earth's magnetic field) is used to distinguish between multiple symbols associated with a tap target. An estimate of an orientation of magnetic flux experienced by a magnetometer attached to the wrist with respect to the axes of that magnetometer during the tap event may be determined based on magnetic flux measurements from that magnetometer. The magnetic flux experienced at the wrist during a tap event may be dominated by magnetic flux caused by the magnetic field of the Earth. For example, measurements from the magnetometer attached to the wrist may be windowed and averaged in a time period corresponding to the tap event to determine an estimate of the magnetic flux due to the magnetic field as a vector represented in the basis of the axes of the magnetometer. Estimates of angles between this magnetic flux vector and the axes of the magnetometer may be determined as needed to classify the orientation of the wrist with respect to the magnetic flux vector. For example, one axis of the magnetometer may be assumed to be approximately parallel to the forearm of the user when the user wears the interface, while the other two axes are perpendicular to the first axis. In some implementations, short term changes in the orientation of the wrist with respect to a magnetic filed may be used to detect changes in orientation of the wrist. By using magnetic flux measurements estimate an orientation with respect to a magnetic field, rotations of the wrist in a plane perpendicular to the acceleration caused by the Earth's gravity may be disambiguated.

For example, a wrist orientation may be determined 1150 by a tap classification module of device driver running on a computing device. In some implementations, a wrist orientation may be determined 1150 by a tap classification module running on a processing device that is attached to the wrist of the user.

A symbol is assigned 1160 to the tap event. A configured mapping (e.g., the mapping illustrated in FIGS. 10A-10C) of tap targets to one or more symbols may be retrieved and used to assign 1160 a symbol to the detected tap event. In some implementations, multiple symbols are associated with a tap target and a symbol is selected from among the multiple symbols associated with the tap target based on the orientation of an acceleration experienced by the accelerometer attached to the wrist of the user. This acceleration may be dominated by an acceleration due to gravity and may provide an estimate of the orientation of the wrist with respect to gravitational field of the Earth. In some implementations, an estimate of the angle between this acceleration and an axis parallel to the forearm of the user may be used to select a symbol (e.g., as described above in relation to FIGS. 5, 6 and 10A-10C). In some implementations, estimates of one or more angles between this acceleration and one or more axes that are perpendicular to length of the forearm may be used to select a symbol (e.g., as described above in relation to FIGS. 7, 8 and 10A-10C). Thus, a user may be enabled to indicate a choice from among the plurality of the symbols associated with the tap target, by adjusting the angle of wrist and/or the angle of a forearm of the user with respect to the gravitational force of the Earth during the tap.

Examples of symbols that may be assigned to a tap include an alpha-numeric character, a Chinese character, a command for a computing device that will cause the computing device to execute an action (e.g., send a text message or e-mail, answer a call, initiate a call dialing sequence, change slides in a presentation, turn on a radio or an air conditioner, etc.), and meta-keys (e.g., ‘shift’) that change the interpretation of a concurrent or subsequent tap, among others.

For example, a symbol may be assigned 1160 by a tap classification module of device driver running on a computing device. In some implementations, a symbol may be determined 1150 by a tap classification module running on a processing device that is attached to the wrist of the user.

The symbol may be transmitted, stored, and/or displayed 1170. In some implementations, the symbol may be transmitted 1170 to another device. For example, a processing device attached to the wrist of the user that performs process 1100 may transmit (e.g., via a wireless communications link) the symbol assigned to a detected tap to a computing device. In some implementations, the symbol may be stored 1170. For example, computing device may buffer a sequence of symbols for later access by an application or some other thread running on the computing device. In some cases, the symbols may be stored in non-volatile memory (e.g., written to a file on a hard-drive when a text file is edited using the interface. In some implementations, the symbol may be displayed 1170 through a display device controlled by the device performing process 1100. For example, a symbol (e.g., an alpha-numeric character) assigned to the tap may be displayed by a projector, or an LCD display on a mobile device (e.g., a smart-phone or tablet), among other types of displays.

In some implementations, process 1100 may be repeated in a loop to process sequences of tap events while the interface is in an active mode.

In some implementations, a user is enabled to turn a palm side of the wrist down to face towards the Earth to enter a cursor manipulation mode, in which acceleration measurements from an accelerometer of the interface (e.g., an accelerometer attached to the wrist of a user) is used to move a cursor in a virtual space. In this cursor manipulation mode, some thumb tap events may be used to interact with object in the virtual space. For example, certain tap targets may be mapped to mouse clicks while the user has their palm facing down toward the Earth.

Other manners initiating or terminating a cursor manipulation mode are possible. For example, a user may execute special gestures (e.g., a particular thumb tap or another type of gesture). In some implementations, an interface is used to track three-dimensional spatial location of a user's hand and sensor data may be used to determine two-dimensional or three-dimensional cursor location. In some implementations, thumb orientation and/or position in relation to the reference frame on the wrist may be used to determine whether the cursor is engaged or not, so that the cursor can continue to be moved in a direction beyond the reach of the user. For example, the cursor may be disengaged when the thumb is oriented approximately perpendicular to the length of the forearm of the user (e.g., held in a thumb-up gesture) and the cursor may be engaged when the thumb is closer to parallel with the length of the forearm. Taps and other spatial gestures can then be used to interact with objects in a virtual space (e.g., replacing mouse clicks or joystick commands). In some implementations, angular rate measurements from a gyroscope in an interface may be interpreted to enable a user to rotate objects in virtual space that have been selected with a cursor while operating in a cursor manipulation mode. For example, a box in three-dimensional virtual space may be selected with the interface by using a gesture (e.g., a sustained thumb tap) to ‘grab’ the object. The box may then be turned or rotated to a desired orientation based on angular rate measurements from a gyroscope attached to a hand (e.g., to a thumb or wrist) of the user as the user rotates their hand. Another gesture (e.g., removing the thumb from a sustained tap target location) may be used to ‘release’ the object, leaving it in the new orientation within the virtual space. In some implementations, a user may be enable to reorient objects in a virtual space based on measurements from an accelerometer and a magnetometer in an interface. For example, the orientation of the hand may be determined at different times as a user turns the hand to manipulate an object by analyzing accelerometer and magnetometer measurements to estimate the orientation of the hand in relation to the background gravitational and magnetic fields (e.g., the Earth's gravity and the Earth's magnetic field). Differences in the estimated orientations with respect to the background fields at two or more times may be used to update the orientation of an object in the virtual space in a corresponding manner.

In some implementations, an interface supports a hand-writing mode. The hand-writing mode enables a user wearing an interface (e.g., an interface including ring 100 and bracelet 200) to draw two-dimensional images by holding a thumb with a sensor module affixed to the thumb in an approximately fixed orientation against a portion of an index finger on the same hand while rubbing the tip of the index finger over a surface. For example, a user wearing ring 100 on a thumb may press the thumb against the medial segment of the index finger and rub the tip of the index finger on the surface of a table in a motion similar to the motion the user would execute to draw or write on the table while holding a pen. A hand-writing mode may allow the user to write text. For example, hand-written text may be presented as an image on a display device controlled by a target computing device that receives data through the interface. In some implementations, automated optical character recognition techniques may be applied to convert portions of an image into text (e.g., stored as ASCII encoded text).

When in hand-writing mode, sensor readings from one or more sensors in a sensor module affixed to a thumb are collected and analyzed while a user rubs their index finger on the a working surface in order to generate a two dimensional image. In some implementations, acceleration measurements are processed to identify an orientation of the working surface with respect to the axes of an accelerometer in the sensor module affixed to the thumb, track motion of the thumb in three dimensional space as the user rubs their index finger on the working surface, and project those motions onto a plane corresponding to the working surface to generate lines and/or curves in the two dimensional plane. In some implementations, angular rate measurements from a gyroscope in the sensor module are used to facilitate cancellation of the acceleration due to gravity for position tracking of the sensor module attached to the thumb. Angular rate measurements may also be used to compensate for slight variations in the orientation of the sensor module on the thumb to working surface as the user moves the tip of the index finger across the working surface.

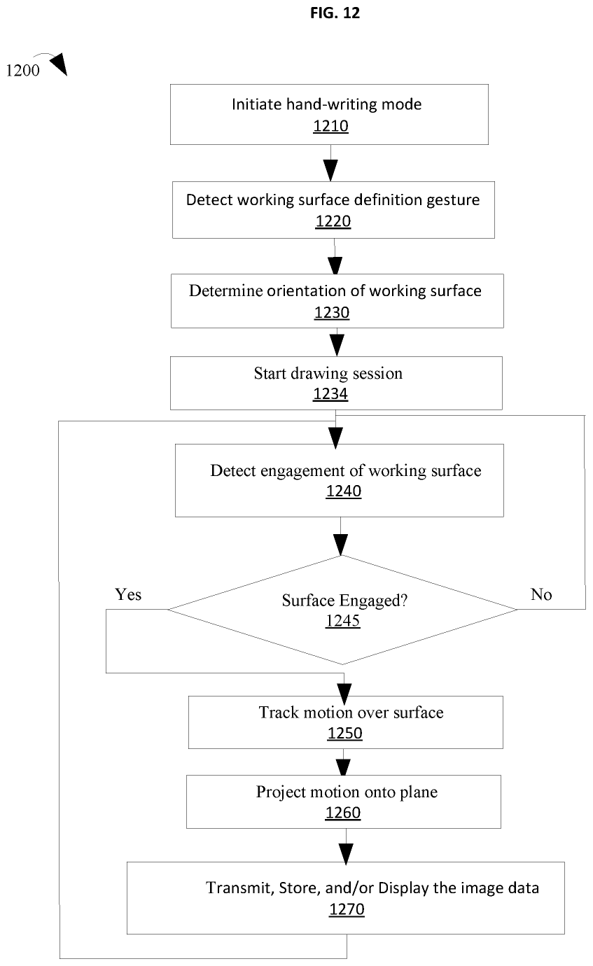

FIG. 12 is a flowchart of an example process 1200 for interpreting signals from a user computing interface while in a hand-writing mode. In some implementations, the process 1200 may be performed by executing driver software for the computing interface on a computing device (e.g., a smart-phone, a tablet device, laptop computer, automobile environmental control system, or a television) that a user seeks to control by making hand gestures while wearing the computing interface. A computing device may include a microprocessor and a data storage device (e.g., flash memory) storing instructions for causing the computing device to perform process 1200. In some implementations, the process 1200 may be performed by a data processing device (e.g., a micro-controller or microprocessor) attached to the wrist of a user and information (e.g., sequences of two-dimensional coordinates, images , and/or text) derived from the signal processing may be transmitted to a computing device that the user seeks to control. In some implementations, a data storage device (e.g., flash memory) storing instructions that cause a data processing device to perform process 1200 may also be attached to the wrist.

The process 1200 may begin when a hand-writing mode is initiated 1210. The hand-writing mode may be initiated in a variety of ways. In some implementations, a gesture made by a user wearing an interface is detected and causes hand-writing mode to be initiated. For example, a user may toggle between modes to select the hand-writing mode by tapping a sensor module affixed to the user's wrist (e.g., component housing 220 of bracelet 200) three times with a finger on the other hand of the user. In some implementations, a sequence of thumb tap gestures may be detected through the interface and cause hand-writing mode to be initiated. In some implementations, hand-writing mode may be initiated when an icon is selected in a cursor manipulation mode. In some implementations, one or more sensor modules of an interface may include one or more mode buttons that enable selection of hand-writing mode from among a set of modes. The initiation of hand-writing mode may be confirmed by visual and/or auditory feedback to the user through output device(s) (e.g., a display device and/or speakers) of a target computing device. In some implementations, initiation of hand-writing mode may be confirmed by tactile feedback (e.g., vibration of a portion of a computing interface).

When hand-writing mode is initiated, the user may be prompted to perform a gesture to define or identify a working surface that the user will be drawing or writing on. In some implementations, the gesture to define the working surface may be detected by detecting certain delimiting gestures that indicate the beginning and end of the surface defining gesture. For example, a user may place the tip of their index finger on the surface, tap their thumb against the medial segment of the index finger and hold the thumb in place against the thumb, then rub the tip of the index finger across the working surface to draw a two dimensional shape (e.g., a rectangle or a circle). Once the shape has been completed, the user may remove their thumb from the index finger and place it in an alternate orientation (e.g., approximately orthogonal to the length of the forearm or on an alternate tap target) to indicate the gesture to define the working surface is complete. During the gesture to define the working surface, sensor measurements from a sensor module affixed to the thumb may be received and recorded.

The orientation of the working surface may be determined 1230 based on sensor measurements recorded during the gesture defining the working surface. In some implementations, the position of the sensor module affixed to the thumb is tracked between the beginning and end of the surface defining gesture to specify a path through three dimensional space. For example, acceleration measurements may be integrated, after canceling the acceleration due to gravity, to determine how the position of the sensor module evolves from the start to the end of the gesture. An estimate of the initial orientation of the gravity vector with respect to the axes of an accelerometer in the sensor module may be estimated at the start of the gesture. For example, when a user first taps the index finger to start the surface defining gesture the gravity vector orientation may be estimated by averaging acceleration measurements during a period of time (e.g., 10, 20, or 50 milliseconds) while the thumb is at rest on the index finger and before the motion of the index finger starts. In some implementations, angular rate measurements may be integrated to update the orientation of the sensor module on the thumb during the gesture to facilitate accurate cancellation of the gravity vector throughout the gesture. In some implementations, the orientation of the sensor module to the working surface and to the gravity vector may be assumed to be constant throughout surface defining gesture and the constant acceleration due to gravity may be subtracted from the acceleration measurements that are integrated to track the position of the sensor module. A plane is then fit (e.g., using a least squares fit) to these points along the path of the sensor module during the working surface defining gesture. For example, the orientation of the fitted plane may be specified by a vector orthogonal to the plane that is represented in the basis of the axes of an accelerometer in the sensor module affixed to the thumb. In some implementations, the plane is further specified by one or more reference points in the plane that specify position of the working surface relative to a reference position in space.

A drawing session may then be started 1234. The start of the drawing session may be confirmed by visual and/or auditory feedback to the user through output device(s) (e.g., a display device and/or speakers) of a target computing device.

After the working surface has been defined and the drawing session has started, engagement of the working surface may be detected 1240. The user may engage the working surface when they are ready to draw or write and disengage when they wish to pause editing of an image or indicate the end of a symbol (e.g., an alpha-numeric character). In some implementations, a user indicates engagement by taping the thumb to a tap position on the index finger (e.g., on the medial segment of the index finger) and holding the thumb in this position against the index finger during the duration of a motion to edit an image. The tap gesture to engage the working surface may be detected by detecting the tap against the tap target and classifying the tap target using techniques described above to determine the orientation of the thumb relative to a reference sensor module (e.g., a sensor module affixed to the wrist of the user). Note that a physical working surface need not actually be touched by the index finger to engage, but touching a physical surface may aid a user to constrain editing motions within a desired plane associated with the drawing. In some implementations, where one or more points in a plane are recorded to specify a position of the working surface and position of the sensor module is tracked throughout the drawing session, engagement may be indicated by touching the working surface with the index finger. For example, proximity of the sensor module to the working surface may be used to detect 1240 engagement of the working surface. When the distance between the sensor module and the working surface is below a threshold and the thumb is in the drawing or engaged orientation, then engagement may be detected. When the distance between the sensor module and the working surface is above a threshold or the thumb is not in the drawing or engaged orientation, then disengagement may be detected.

In some implementations, different taps of the thumb against different targets between engagements of the working surface may be used for selecting different virtual writing utensils (e.g., different line widths, fonts, font sizes, etc.). Once the virtual writing instrument is selected the usual working surface engagement gesture may be used to start using the selected virtual utensil to edit an image.

When the working surface is engaged 1245, the position of the sensor module is tracked 1250. For example, acceleration measurements may be integrated, after canceling the acceleration due to gravity, to determine how the position of the sensor module evolves during engagement with the working surface. In some implementations, the orientation of the sensor module to the working surface and to the gravity vector may be assumed to be constant throughout the engagement period and the constant acceleration due to gravity may be subtracted from the acceleration measurements that are integrated to track the position of the sensor module. In some implementations, the gravity vector estimate may be updated from time to time to correct for sensor drift. The gravity vector estimate may be updated at points when the user's thumb is assumed to be at rest with respect to the working surface (e.g., during user initiated or prompted pauses for recalibration). In some implementations, angular rate measurements may be integrated to update the orientation of the sensor module on the thumb during the gesture to facilitate accurate cancellation of the gravity vector throughout the gesture. In some implementations, position estimates derived from the acceleration measurements and/or angular rate measurements may be adjusted based on the angular rate measurements to account for small variations in the orientation of the sensor module with respect to the working surface as the tip of the index finger is moved across the surface. For example as the orientation of the sensor module to the plane associated with the working surface changes slightly, it may reflect the sensor module moving slightly closer or further from the working surface and a corresponding slight change in the distance within the plane between the contact point of the index finger with the working surface and the projection of the sensor module position onto the plane. Accounting for these fine differences may provide a smoother drawing experience by making the drawing more consistently shadow the motions of the tip of the index finger on the working surface.

While the surface is engaged 1245, changes in the tracked position of the sensor module in three dimensional space are projected 1260 onto the plane corresponding to the working surface to derive a two dimensional representation of the motion of the index finger across the working surface. Data reflecting this two dimensional representation (e.g., text or other forms of data encoding a two dimensional image) of the motion may then be transmitted, stored, or displayed 1270. In some implementations, two dimensional coordinates corresponding to pixels in an image to be updated based on the motion are transmitted or stored 1270 for further processing.

Engagement of the working surface may be continually monitored to detect 1240 when a disengagement occurs while the image editing continues. When the surface ceases to be engaged 1245, the image editing can be paused while detection of the re-engagement continues. In some implementations, during hand writing of text the working surface may be disengaged after the completion of each character to delimit the character image and cause it to be passed to an automatic optical character recognition module. The process 1200 may continue in this loop until the drawing session is terminated. For example, the drawing session may be terminated by a mode selection gesture similar to the gesture used to initiate the drawing session.

In some implementations, an interface (e.g., including ring 100 and bracelet 200) can provide a secure mechanism for authenticating a user with a target device. First, a secure communication channel may be established. For radio frequency communication between an interface device and a target computing device, public-key cryptography may be employed to secure the communications. In some implementations, an initial device pairing process may be performed in which public keys are exchanged between an interface device and a target computing device. For example, near field communications (NFC) may be used to exchange public keys between an interface device and a target computing device. NFC may be used to minimize the chance of “man-in-the-middle” (MITM) attacks. In an example scenario, after the public keys are exchanged, the interface device can authenticate itself to the target device in the following steps:

1. interface device generates a random message “A_m”

2. interface device signs A_m using its private key, yielding A_private(A_m).

3. interface device, using target computing device's public key, encrypts
i. A_private(A_m), yielding T_public(A_private(A_m))
ii. A_m, yielding T_public(A_m)

4. interface device sends both encrypted messages to target computing device.

5. Target computing device, on receiving both messages, using its private key, decrypts
i. T_public(A_private(A_m)), yielding A_private(A_m)
ii. T_public(A_m), yielding A_m

6. Target computing device decrypts A_private(A_m) using interface device's public key.

7. Target computing device compares the message decrypted with the interface device's public key to the extra copy of the message to confirm that the messages are the same and that the sender possesses the private key of the interface device.

The target computing device authenticates itself to the interface device in a similar manner. After successful authentication, the devices can send encrypted messages (sensor measurements, symbols, commands, etc) using the public keys. The interface device can send an encrypted message to the target computing device as follows:
1. The interface device encrypts a message (S) (e.g., a set of sensor measurements), using the target computing device's public key, yielding T_public(S)
2. The interface device sends T_public(S) to the target computing device.
3. The target computing device decrypts T_public(S) using its private key, yielding S

The target computing device can send encrypted commands or other data to the interface device in a similar manner. For example, public keys may be exchanged using NFC and data may be exchanged over an encrypted Bluetooth communication channel that uses the public keys for encryption.

After it has been established that the interface device and one ore more target computing devices can authenticate and communicate securely, a user of the interface may be authenticated through the interface. In some implementations, a user may be authenticated by entering a character based password which consists of tapping a sequence of tap targets. That sequence may be interpreted as a set of symbols which the target computing device can verify against a registered password for the user. In some implementations, a user be authenticated by performing a gesture in 3-dimensional space. For example, a simple horizontal wave of the user's hand could be interpreted as a gesture to unlock the target computing device display. For better security, the target computing device may require a more complex gesture that consists of some combination of gestures by the thumbs and/or arms simultaneously. For example, such a gesture could be a combination of the baseball “safe” gesture with the arms and thumb swipe gesture from the distal to the proximal phalanges of the middle fingers. Each user may configure their own personalized gesture based password.

In some implementations, during a registration or configuration process for the computing device, a user may record the gesture the user wishes to use for unlocking the target computing device. To authenticate the user, a recording of sensor measurements (e.g., acceleration measurements) may be cross-correlated with the a recording of sensor measurements for a gesture that was previously recorded during a registration session. For example, if the cross-correlation is above a threshold, the user maybe granted access to the computing device, otherwise the user may be denied access to the target computing device. The user may be prompted to record the gesture multiple times during registration to confirm that the gesture is repeatable in a reliable manner for the user. For example, if a cross-correlation between a set of sensor measurements recording during the gesture instances is below a threshold the gesture may be rejected as an acceptable password and the user may be prompted to select a different gesture based password. In some implementations, a user may set both a gesture based password and and alternative character based password. The gesture based password may be used for quick access to a secured target computing device, while the character based password may be used as a fall back in case the interface device is unavailable or the user has difficulty reproducing a previously recorded gesture based password.

Gesture based passwords input through the interface can be implemented for quick access to target computing device without touching a keyboard/other input system. For example when a physician wants to see medical images in wearable or wall/desk display & access via password controlled file system without typing on a keyboard.

The interface device may be used in conjunction with other security devices. For example a system may employ gesture based password valid only if additional credential such an identification badge with radio-frequency identification (RFID) is also within a required range.

For some interfaces, a 3-dimensional cursor/pointer mode may be enabled by a user through a sequence of taps of the thumb or through hand and arm movement. When enabled, the user may have 6 degrees of freedom of movement, as the cursor may be moved and rotated in a 3-dimensional virtual space. In this mode, some gestures may be interpreted in an application-specific manner that allows a user to easily access the functions available in a particular application. For example, when interacting with a drawing application, double tapping the distal, middle, or proximal phalanges of the index finger may correspond to selecting the red, green, or blue paint brushes. Further, tapping and holding the same phalanges while performing a drawing gesture may correspond to drawing using successively heavier brushes with the previously selected color.

For other applications, such as games, the same gestures may be interpreted differently. For shooting games, for example, tapping the proximal phalanx of the index finger may correspond to toggling through a selection of different type of weapons available, such as hand guns, shotguns, or bazookas. Tapping the distal phalanx may correspond to firing the selected weapon. Tapping and holding the distal phalanx may correspond to repeating the same shooting action. Further, swiping from the middle phalanx to the proximal phalanx may correspond to zooming in at a target, holding the swipe at the proximal phalanx and moving the arm may correspond to aiming at the target, and then letting go of the phalanx may correspond to shooting.

A control parameter (e.g., sound volume, mute control, zoom factor, hide/show menu, or scroll bar position) for a target computing device may be adjusted when a user wearing a computing interface (e.g., including ring 100 and bracelet 200) performs a control parameter adjustment gesture. In some implementations, a control parameter adjustment gesture may include tapping and holding the thumb of a user against a tap target on a finger of the user that has been associated with the control parameter and then changing the orientation of the hand and/or arm of the user to adjust the value of the control parameter. In some implementations, the change in the orientation of the user's hand and/or arm may be detected using a gyroscope in the computing interface (e.g., a gyroscope in bracelet 200 attached to the user's wrist). In some implementations, the change in the orientation of the user's hand and/or arm may be detected using an accelerometer and/or a magnetometer in the computing interface (e.g., an accelerometer and/or a magnetometer in bracelet 200 attached to the user's wrist) to estimate changes in the relative orientation of gravitational and/or magnetic fields experienced by the computing interface. In some implementations, the control parameter adjustment gesture is terminated when the user removes their thumb from the tap target associated with the control parameter. In some implementations, the control parameter adjustment gesture is terminated when the user moves their thumb into an orientation that is approximately orthogonal to the length of the user's forearm (e.g., the thumb into a thumbs up position).

For example, when a music player application is running on a target computing device, the sound volume may be adjusted by tapping the thumb of the user wearing ring 100 against a tap target on a finger of the user (e.g., on the medial segment of the index finger) and then bending the arm at the elbow to change the inclination of the user's forearm including the wrist. As the wrist moves up, the sound volume may be increased, or as the wrist moves down, the sound volume may be decreased. In some implementations, the sound volume may be adjusted by an amount that is proportional to the amount of the change in inclination of the wrist. In some implementations, the sound volume may be adjusted by an amount that is proportional to the rate of the change in inclination of the wrist.

In another example, when a web browser application is running on a target computing device, a scroll bar position may be adjusted by tapping the thumb of the user wearing ring 100 against a tap target on a finger of the user (e.g., on the medial segment of the middle finger) and then waving the hand in circle in front of the user as if turning a steering wheel or dial. As the hand and wrist moves clockwise, the browser window may be scrolled down, or as the hand and wrist moves counter-clockwise, the browser window may be scrolled up.

As the gestures may be interpreted in an application-specific way, they may be mapped or programmed by developers as appropriate for their application. Furthermore, an application may be built so as to allow users to map gestures to actions in such a way that is most intuitive to them.

Mode shifts such as entering or exiting a text entry mode, cursor manipulation mode, or a hand-writing mode may be triggered in part based on additional application and/or context sensitive decision factors. For example, if the user is playing a game, at certain point 3D mouse mode may be possible through a mode shift gesture (e.g., triple-tapping a sensor module affixed to a wrist with a finger of the opposite hand). At other points in the game, 3D mouse mode may be disabled. The software game or other application may determine the mode options available and an interface application or driver running on the target computing device or on the interface device itself may be able to adjust output accordingly. In some implementations, the interface device (e.g., including ring 100 and bracelet 200) may control which modes are available and initiate transitions between the available modes. In some implementations, application or driver software running on a target computing device may control which modes are available and initiate transitions between the available modes.

Users may be able to define universal gesture (e.g., thumb tap) master commands that are similarly interpreted by a large number of applications running on target computing devices. For example, one may employ double tap of a thumb to a middle finger to pause content (e.g., game, music, or video being played). In some implementations, a user may pause or stop the play of media or games in various contexts by bending the user's hand and thumb back at the wrist to make a ‘stop’ hand signal. For example, the orientation of a thumb wearing ring 100 relative to a wrist wearing bracelet 200 may be determined to detect when the angle between the direction the thumb is pointing and a vector emanating from the back of the wrist is smaller than a threshold angle in order to detect a stop hand signal that triggers a pause of content. Such customizable commands that the user may employ broadly may help reduce variation in user experience across platforms. These customizations may be kept as a part of a user profile, e.g., information for a user stored within the interface device or maintained on various target computing devices.

A computing interface (e.g., including ring 100 and bracelet 200) may change its mode of operation based on changes in the context in which it is used. Context changes may include changes in the state of the hardware or software running on a target computing device. For example, when the target computing device loses or regains network connectivity, the computing interface may change its mode of operation to help address the interruption in service. When the target computing device has network connectivity, the computing interface may be used to control a device remotely connected to the target computing device through a network. When the target computing device loses network connectivity, the computing interface may be notified, so that it switches contexts to better or more efficiently control the target computing device (e.g., to recognize gestures that facilitate changing settings for re-establishing network connectivity and/or to power down sensors or other components of the computing interface that are not needed when the remotely connected device is not being controlled). Context switching may require the computing interface to provide authentication data and other information (e.g., from a database of profiles of known target computing devices) with the target computing devices.

Context changes may also include changes in the physical environment and/or the status of the user of the computing interface. Various sensors (e.g., accelerometers, thermometers, gyroscopes, magnetometers, capacitive sensors, or optical sensors) in a computing interface may be used detect changes in the state of a user and/or their environment. In some implementations one or more accelerometers in a computing interface are used to detect an activity state of a user. For example, when a user runs while wearing a computing interface (e.g., including ring 100 and bracelet 200), this activity may be reflected in periodic signals in the measurements from the accelerometer(s) that are caused by the user swinging their arms. When this type of activity is detected, a context changes may be initiated that changes the mode of operation of the computing interface and/or the target computing device to enable or disable certain gestures that might otherwise be available given the state of the target computing device. For example, during a jogging/running activity, the computing interface may disable change-volume gestures to prevent accidental adjustment of sound volume. When the activity changes to walking, the computing interface may switch to a context that enables sound volume adjustment. When the activity changes to rest or sleeping, the computing interface may switch to a context that disables most gestures and/or powers down some or all of its sensors to save energy. In some implementations, a motor vehicle riding state may be detected as a context change. For example, riding in a motor vehicle may be detected by using an accelerometer to detect vibrations characteristic of a motor and/or to detect sustained velocities exceeding a threshold (e.g., by integrating linear acceleration measurements).

In some implementations, a computing interface may store or access device profiles for the target computing devices that it is configured to control. Device profiles may include information for a target computing device, e.g., about its features, states, and authentication data. Internally, a device profile may be used by the computing interface to keep track of its states. Externally, portions of profiles may be multicasted by the computing interface to share its contexts with known target computing devices.

A computing interface may also store or access a user profile that it can pass to target computing devices as needed. For example, a computing interface switching to the “sleep context” may multicast a “sleep profile” containing information such as a limited set of gestures it supports and the heart rate and perspiration level of the user to nearby target computing devices. On receiving this profile, a TV may turn off, an air conditioning control system may adjust ambient temperature accordingly, and/or a telephone may go into do-not-disturb mode where ringing or other forms of notification (e.g., ringing, flashing an LED, vibration) are disabled. When a user enters their home, the computing interface may switch to a “home context” and multicast a “home profile” containing information that initiates a process in which the user can authenticate to unlock the door. Furthermore, the computing interface can switch to additional contexts within the “home context”, such as a “tv context” when the user interacts with the TV. In the “tv context”, a “tv profile” may be multicasted to the TV, declaring the set of gestures that the computing interface supports for interacting with the TV. On receiving the “tv profile”, the TV can map the supported gestures to the corresponding supported functions (e.g., mapping the index-finger swipe to volume control).

In some implementations, an interface device (e.g., including ring 100 and bracelet 200) may be used to interact with and to interchangeably control multiple different target computing devices. For example, the target computing devices controlled with one interface may include a mobile phone, a television, a desktop computer, automobile environment control console, etc. Each target computing device may have a profile that specifies characteristics of the interface when paired with that target computing device (e.g., recognizable taps, gestures, and input modes). Different devices (and, thus, their profiles and input modes) may be selected by performing a device specific gesture. After a target computing device has been selected, sensor measurements and/or information derived from sensor measurements are transmitted from the interface device to the selected target computing device for processing. For example, a user working in an office may select his desktop computer as the target to send his gesture input. After he leaves his office, he may go to his car and selects the car environment control console as the target to send his gesture input. When he gets home, he may select his television as the target computing device to send his gesture input. The targets in this example may have different characteristics and may interpret a gesture similarly or differently.

In some implementations, where a computing interface includes a processing device configured to interpret sensor measurements and detect gestures (e.g., thumb taps), a target device may be selected using a pre-configured gesture that is unique to a particular target computing device. In a variation, a target device may be selected by toggling through a list of configured target computing devices using a universal device selection gesture. When a device is selected, it may provide feedback to the user, such as either visual (e.g., flashing screen), audible (e.g., beeping), or tactile (e.g., vibrating) feedback.

In some implementations, where applications or drivers running on target computing devices are configured to interpret sensor measurements for the interface, the applications or drivers may be configured to cooperate in enabling the user to switch between target computing devices. For example, an application or driver running on a target computing device that recognizes a device change/selection gesture made through the interface may send commands back to a micro-controller on the interface device to command it to start a new search for target computing devices within wireless communications range (e.g., using the Bluetooth device discovery protocol) and terminate the current interface session (e.g., by terminating the current Bluetooth channel).

In some implementations, a computing interface described above is paired with a display to facilitate user data entry in various ergonomic positions. For example, the interface (e.g., including one or more sensors worn on the thumb and one or more sensors worn on the wrist) may be connected to a processing device, such as a computer, which is in turn connected to a display device, such as a projector. A user's body is oriented in a comfortable position and the display is positioned in the user's natural line of sight. For example, a user may lie in a bed or in a reclining chair and view a display projected onto the ceiling. From this position, the user may enter data via the interface and receive visual feedback via the display. Data entry mode may be started and stopped by distinctive motions of the hand that are detected with one or more accelerometers in the interface. For example movement of the hand quickly in a circle may be used to indicate the start or stop of a data entry session. The orientation of a plane in which this circular motion occurs may be used to set a reference earth radius angle for the session. Earth radius angles estimated during the session may be rotated by an amount determined by the orientation of the plane of the circular motion. For example, if the plane of the circular motion is parallel to the detected gravitational acceleration, then the measured wrist orientations may be left unadjusted, while, if the plane of the circular motion is orthogonal to the detected gravitational acceleration (e.g., because the user is lying on their back while making the circular motion in front of them), the measured wrist orientations may be rotated by 90 degrees to recover orientations with respect to the user's body. In this manner a user's training with one set of wrist orientations may be used while the body is in different positions.

The computing interface may be used to control a wide variety of computing devices in different contexts. For example, a computing interface including a ring may be used to control one or more processing devices integrated in an automobile. Gestures (e.g., thumb taps) may be used to control various environmental systems in the automobile. For example, a tap target may be mapped to a command for turning an air conditioner on. Another tap target may be mapped to a command for turning a radio on. Another tap target may be mapped to a command for seeking or selecting a radio station. Another tap target may be mapped to a command for unlocking a door, and so on.

In some implementations, measurement data from sensors in an interface or other information (e.g., symbols) based on the sensor measurements may be transmitted to multiple target processing devices. For example, an interface may be used to broadcast symbols derived from sensor measurements reflecting user hand motions for display on multiple displays.

In some implementations, a interface described herein is paired with a visual gesture recognition system. The position tracking capability of the interface may be used in conjunction with data from the visual sensors (e.g., camera(s)) to enhance detection of gestures. For example, when the line of sight between the visual sensor and the thumb or the entire hand is obscured, data from the interface may be used to interpolate gestures.

In some implementations, an interface includes sensor modules or housings that are detachable from a corresponding fastening article (e.g., a thumb ring or a wrist band). Thus, fastening articles may be interchangeable. A user may own multiple fastening articles and switch between them for various reasons, such as aesthetics or comfort. For example, alternative fastening articles may be different colors or some fastening articles may include jewels or other aspects of traditional jewelery.

Any processes described herein, are not limited to the hardware and software described above. All or part of the processes can be implemented as special purpose logic circuitry, such as an FPGA (Field Programmable Gate Array) and/or an ASIC (Application Specific Integrated Circuit). All or part of the processes can be implemented, at least in part, via a computer program product tangibly embodied in non-transient computer-readable media, for execution by or to control the operation of one or more data processing apparatus, such as a computer, special purpose microprocessor, or programmable logic components. A computer program can be written in any programming language, including compiled or interpreted languages. A computer program can be implemented as a stand-alone program or as portion, such as a module or subroutine, of a larger program. A computer program can be deployed to be executed on a single data processing device or on multiple data processing devices.

Components of different implementations described above may be combined to form other implementations not specifically described above. Other implementations not specifically described above are also within the scope of the following claims.

What is claimed is:

1. A method comprising:
receiving a first set of acceleration measurements from a first accelerometer that is attached to a thumb of a user;
detecting a working surface definition gesture;
determining an orientation of a working surface based at least in part on a portion of the first set of acceleration measurements corresponding to the working surface definition gesture, in which determining the orientation of the working surface comprises determining a path through three dimensional space traversed by the first accelerometer during a working surface definition gesture, and fitting a plane to the path using a least squares fit;
detecting, based at least in part on the first set of acceleration measurements, a first event corresponding to engagement of a working surface;
during the first event, tracking motion of the first accelerometer, based at least in part on the first set of acceleration measurements;
determining, based at least in part on the tracked motion of the first accelerometer during the first event, image data; and
transmitting, storing, or displaying the image data.

2. The method of claim 1, in which the working surface corresponds to a physical surface.

3. The method of claim 1, comprising determining a three dimensional position of at least one point on the working surface.

4. The method of claim 1, comprising estimating an orientation of a gravity vector based on a portion of the first set of acceleration measurements corresponding to a time period at the beginning of the working surface definition gesture.

5. The method of claim 1, comprising:
receiving a second set of acceleration measurements from a second accelerometer that is attached to a wrist of the user; and
wherein detecting the working surface definition gesture comprises detecting, based at least in part on the first set of acceleration measurements and the second set of acceleration measurements, when the thumb of the user is placed in contact with a medial segment of an index finger of the user.

6. The method of claim 1, comprising:
receiving a second set of acceleration measurements from a second accelerometer that is attached to a wrist of the user; and
wherein detecting the first event comprises detecting, based at least in part on the first set of acceleration measurements and the second set of acceleration measurements, when the thumb of the user is placed in contact with a medial segment of an index finger of the user.

7. The method of claim 6, comprising detecting a termination of the first event by detecting, based at least in part on the first set of acceleration measurements and the second set of acceleration measurements, when the thumb of the user is place in an orientation approximately orthogonal to the length of a forearm of the user.

8. The method of claim 1, comprising:
receiving a second set of acceleration measurements from a second accelerometer that is attached to a wrist of the user;
receiving a first set of magnetic flux measurements from a first magnetometer that is attached to the thumb of the user;
receiving a second set of magnetic flux measurements from a second magnetometer that is attached to the wrist of the user; and
wherein detecting the first event comprises detecting, based at least in part on the first set of acceleration measurements and the second set of acceleration measurements and the first set of magnetic flux measurements and the second set of magnetic flux measurements, when the thumb of the user is placed in an orientation indicating engagement of the working surface.

9. The method of claim 1, in which detecting the first event comprises:
tracking position of the first accelerometer; and
detecting when a distance between the first accelerometer and the working surface is below a threshold.

10. The method of claim 1, comprising:
detecting, based at least in part on the first set of acceleration measurements, a tap of the thumb of the user against a tap target on a finger of the user; and
configuring, based in part on the tap detected, a virtual writing utensil for editing an image based on the tracked motion of the first accelerometer during the first event.

11. The method of claim 1, in which determining the image data comprises:
receiving a first set of angular rate measurements from a first gyroscope that is attached to the thumb of the user; and
compensating, based at least in part on the first set of angular rate measurements, for variations in the orientation of the first accelerometer with respect to the orientation of the working surface.

12. The method of claim 1, comprising:
receiving a second set of acceleration measurements from a second accelerometer that is attached to a wrist of the user;
detecting, based at least in part on the second set of acceleration measurements, a sequence of taps against a sensor module housing the second accelerometer; and
initiating a hand-writing mode upon detection of the sequence of taps against the sensor module.

13. The method of claim 12, in which initiating hand-writing mode comprises prompting the user to perform a working surface definition gesture.

14. The method of claim 1, in which the image data is encoded as text.

15. A system comprising:
a data processing apparatus;
a data storage device storing instructions executable by the data processing apparatus that upon execution by the data processing apparatus cause the data processing apparatus to perform operations comprising:
receiving a first set of acceleration measurements from a first accelerometer that is attached to a thumb of a user;
detecting a working surface definition gesture;
determining an orientation of a working surface based at least in part on a portion of the first set of acceleration measurements corresponding to the working surface definition gesture, in which determining the orientation of the working surface comprises determining a path through three dimensional space traversed by the first accelerometer during a working surface definition gesture, and fitting a plane to the path using a least squares fit;
detecting, based at least in part on the first set of acceleration measurements, a first event corresponding to engagement of a working surface;
during the first event, tracking motion of the first accelerometer, based at least in part on the first set of acceleration measurements;
determining, based at least in part on the tracked motion of the first accelerometer during the first event, image data; and
transmitting, storing, or displaying the image data.

16. The system of claim 15, in which the working surface corresponds to a physical surface.

17. The system of claim 15, in which the operations comprise:
receiving a second set of acceleration measurements from a second accelerometer that is attached to a wrist of the user;
receiving a first set of magnetic flux measurements from a first magnetometer that is attached to the thumb of the user;
receiving a second set of magnetic flux measurements from a second magnetometer that is attached to the wrist of the user; and
wherein detecting the first event comprises detecting, based at least in part on the first set of acceleration measurements and the second set of acceleration measurements and the first set of magnetic flux measurements and the second set of magnetic flux measurements, when the thumb of the user is placed in an orientation indicating engagement of the working surface.

18. The system of claim 15, in which detecting the first event comprises:
tracking position of the first accelerometer; and
detecting when a distance between the first accelerometer and the working surface is below a threshold.

19. The system of claim 15, in which the operations comprise:
detecting, based at least in part on the first set of acceleration measurements, a tap of the thumb of the user against a tap target on a finger of the user; and
configuring, based in part on the tap detected, a virtual writing utensil for editing an image based on the tracked motion of the first accelerometer during the first event.

20. The system of claim 15, in which the operations comprise:
receiving a second set of acceleration measurements from a second accelerometer that is attached to a wrist of the user;
detecting, based at least in part on the second set of acceleration measurements, a sequence of taps against a sensor module housing the second accelerometer; and
initiating a hand-writing mode upon detection of the sequence of taps against the sensor module.
